(19) United States
(12) Patent Application Publication
(10) Pub. No.: US 2004/0090468 A1
(43) Pub. Date: May 13, 2004

(54) System and method for automated creation of personalized poster

(75) Inventors: Terry L. Cruikshank, Cherry Hill, NJ (US); Douglas August, Lumberton, NJ (US); Barry L. McElreath, Moorestown, NJ (US); Timothy O'Shea, Medford, NJ (US); George A. Rears, Mount Laurel, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Okidata Americas, Inc., Mount Laurel, NJ

(21) Appl. No.: 10/701,187

(22) Filed: Nov. 4, 2003

Related U.S. Application Data
(60) Provisional application No. 60/423,828, filed on Nov. 5, 2002.

(51) Int. Cl. G09G 5/00

(52) U.S. Cl. 345/838

(57) ABSTRACT

An apparatus and a method for a user to create a poster having one or more of images is disclosed. The method includes the steps of (a) prompting the user to select a template corresponding to a type of poster; (b) prompting the user to select one of a plurality of image sources; (c) receiving one or more images from the selected one of the plurality of image sources; (d) prompting the user to select one or more of the one or more received images; (e) repeating steps (b) through (d) until a desired number of images is selected; (f) placing the selected images on the template; and (g) outputting a signal representative of the poster.

### CROSS REFERENCE TO RELATED APPLICATIONS

This application claims the benefit of U.S. Provisional Application No. 60/423,828 filed Nov. 5, 2002, entitled System and Method for Automated Creation of Personalized Poster, the contents of which provisional application are incorporated herewith in their entirety.

### BACKGROUND OF THE INVENTION

The present invention relates generally to a method and system for creating professional looking high quality posters and, more particularly, to such a method and system which facilitates the automated creation of such posters by an individual having no specialized knowledge or experience with respect to the creation of posters. For purposes of the present application, the term “poster” includes signs, banners, announcements, calendars and the like which may include both images and text.

Most of the posters currently available are preprinted 24-inch by 36-inch photographs of music, movie and sports celebrities, reprints of well-known art pieces, famous locations and special event memorabilia (i.e., concerts, exhibits, etc.) and the like and do not provide an opportunity for individual personalization. In addition, the prices charged for such preprinted posters can range from $15 to $100. Customized posters are generally limited to: (1) posters which are professionally made through a printer, copy center or photo shop, (2) posters which are hand created or (3) posters which are created on a personal computer using prepackaged software and an inkjet printer. Some copy centers and photo shops print poster sized photographs and even customize such photographs using a large inkjet printer. However, posters created in this manner are relatively expensive ($25-$75) and may take as much as several days to produce. In addition, photo shops generally produce existing photography with limited opportunities for personalization and typically are limited to a maximum size of 8 inches by 10 inches. Creating a poster by hand is problematic because the results are generally unprofessional looking, have a limited life and take substantial time, in addition to the costs involved in purchasing the poster paper, art supplies, etc. Creating a poster on a personal computer and printing the poster on a standard inkjet printer produces a slightly more professional looking poster. However, printing is limited to 8½-inch wide banner paper and a substantial amount of personal attention is required to obtain a satisfactory result. To produce a more professional result, a user would need access to and most likely experience with professional design software, as well as access to a more expensive, generally commercial grade printer.

The present invention overcomes the problems associated with the prior art by providing a walk-up, stand-alone user friendly kiosk workstation that permits users to easily, affordably and quickly (15 minutes or less) create unique, personalized color posters using any of a plurality of preestablished selectable formats or templates along with a combination of a wide variety of stored, stock images or user-supplied images. Each poster is further personalized by the user adding his or her own title, captions and other text within the confines of the selected template. This permits a user to create a poster to memorialize or commemorate an event that is relevant only to the user. The poster may be created in different orientations (horizontal or vertical) and different sizes. Once the personalized poster has been created, the user can view and edit the poster before the poster is actually printed. Printing of the poster is accomplished using a high quality printer to print the created poster on special waterproof, tear resistant material of a size determined by the size of the created poster. The printer prints the final poster in full color within a few minutes, thereby eliminating the need for the user to wait for a lengthy printing process or to return to pick up the poster some other day.

### BRIEF DESCRIPTION OF THE SEVERAL VIEWS OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a preferred embodiment of a kiosk workstation for automated creating of personalized posters in accordance with the present invention;

FIG. 2 is a block diagram schematic showing the principal subassemblies of the workstation of FIG. 1;

FIG. 3A is a first portion of a flow diagram illustrating the preferred steps employed by a user in creating a poster utilizing the workstation of FIG. 1;

FIG. 3B is a second portion of a flow diagram illustrating the preferred steps employed by a user in creating a poster utilizing the workstation of FIG. 1; and

FIGS. 4A-4G are examples of attract mode screens;

FIG. 4H is an example of a screen for selecting a type of poster;

FIG. 4I is an example of a screen for selecting the size and format of a poster;

FIGS. 4J and 4K are examples of screens for selecting the type of calendar layout and starting date of the calendar;

FIG. 4L is an example of a screen for selecting an image source;

FIG. 4M is an example of a screen for selecting a category of photo from a photo gallery;

FIG. 4N is an example of a screen displaying images received from the selected image source;

FIG. 4O is an example of a screen for editing an image;

FIGS. 4P and 4Q are examples of screens for inputting caption and title text;

FIG. 4R is an example of a screen for previewing a created poster;

FIG. 4S is an example of a screen for placing an order for the created poster;

FIG. 4T is an example of a screen containing a legal disclaimer;

FIG. 4U is an example of a screen directing the user to the attendant when printing of the poster is completed.

FIG. 4V is an example of a screen for making final changes to the created poster;

FIGS. 5A-5FF are flow diagrams illustrating, in greater detail than is shown on FIGS. 3A-3B, the functionality of the software employed for controlling the operation of the workstation kiosk; and

FIGS. 6A-6Q illustrate in greater detail than is shown in FIGS. 4A-4U, the various screen layouts which may be displayed as a user creates a poster.

### DETAILED DESCRIPTION OF THE INVENTION

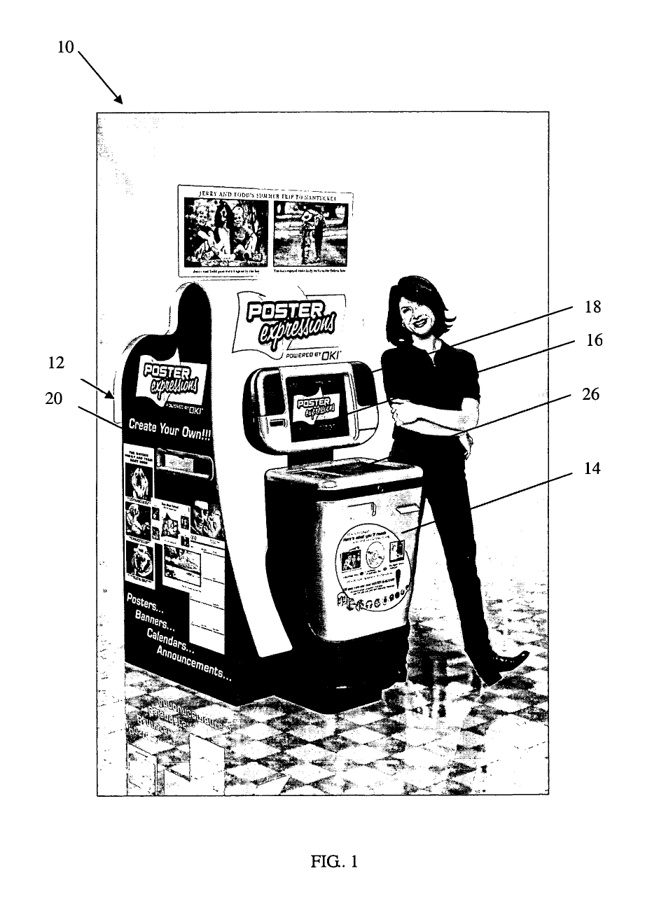

Referring to the drawings in detail, wherein like numerals indicate like elements throughout and the use of the indefinite article “a” may indicate a quantity of one or more than one of an element, there is shown in FIG. 1 a preferred embodiment of a kiosk workstation 10. Preferably, the kiosk workstation 10 is installed in a retail facility such as a discount or variety store, department store, convenience store, or the like. Alternatively the kiosk workstation 10 may be installed in some other facility or in a more generalized location such as within the common area of a mall. The precise location of the kiosk workstation 10 is not important for a complete understanding of the present invention.

The kiosk workstation 10 includes a housing 12 which is suitably formed of a combination of lightweight high strength materials and is decorated with suitable bright colors and indicia to attract users. The housing 12 includes a front panel portion 14 accessible by a user which incorporates operating features including a touch screen monitor 16, speakers 18, a scanner 26 and other indicia and input devices to assist a user in designing and developing a unique personalized poster. The housing 12 further includes an output slot or opening 20 to facilitate removal of a completed printed poster.

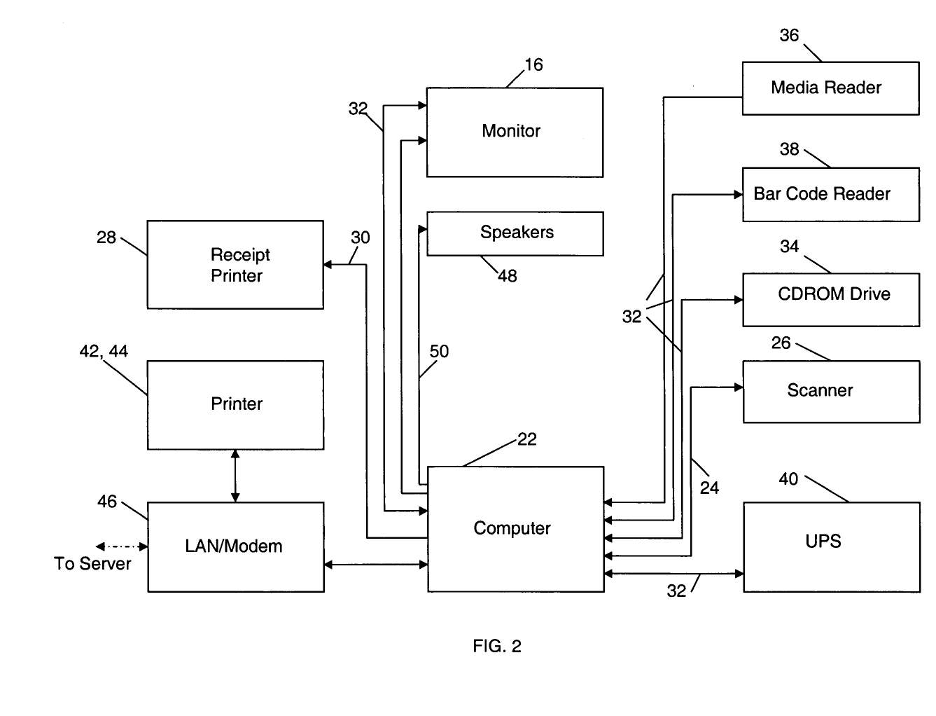

FIG. 2 is a schematic block diagram illustrating the principal subassemblies of the workstation 10. A computer 22, including associated software, controls the functioning of the workstation 10 and the other components and subassemblies. In the preferred embodiment, the computer 22 is an Omni Tech OEM V2300D00 industrial grade computer which includes a Pentium class microprocessor, preferably a high speed Pentium IV microprocessor, 512 megabytes of random access memory (RAM), six universal serial bus (USB) ports, a parallel port, a 10/100 Ethernet interface and an 80-gigabyte hard drive. A plurality of images, i.e. photo gallery, is stored on the hard disk as one of several possible sources of images for use in creating the poster. As used in this application, an image is defined as any information that is stored and processed in the workstation 10 as a graphics file. Text information is defined as one or more characters that are stored and processed in the workstation as a text file. The computer 22 includes built in software diagnostics that automatically send out a notification to a remote server (see below) if a problem occurs. The computer 22 operates with a Microsoft Windows 2000 operating system. It will be appreciated by those of ordinary skill in the art that other types of computers having other types of processors and memory, and operating under a different operating system may alternatively be employed.

In addition to providing the images stored in the photo gallery as a source of images, the workstation 10 provides the capability of enhanced personalization of the posters by including one or more personal input devices as a source of the images. The personal input devices permit a user to input his or her personal images (photographs, drawings, or the like) into the computer 22 to facilitate the creation of a personalized poster utilizing the user-supplied and/or the photo gallery images.

In the preferred embodiment, as illustrated in FIG. 2, the personal input devices include a scanner 26, which preferably is a flatbed-type scanner, connected through a USB connection 24 to the computer 22. Preferably, the scanner 26 is a state-of-the-art full color scanner with relatively high resolution. Preferably the scanner 26 is a generally available, off-the-shelf scanner obtained from a well-known scanner manufacturer, for example a Model 1670 from Epson. Further details concerning the structure and operation of the scanner 26 and the USB connection 24 are not necessary for a complete understanding of the invention.

In the preferred embodiment, the personal input devices also include, a DVD/CD ROM drive 34, a digital media card (multi-media) reader 36 and a bar code reader 38 (to assist a user in reprinting a previously created poster), each of which is connected to the personal computer 22 through the USB connection 32. Other such personal input devices may be used in addition to or as an alternative to the devices shown in FIG. 2 in order to permit a user to input his or her personal graphic or image data in whatever form the image data is stored, and to provide for maximum flexibility in creating a personalized poster. The DVD/CD ROM drive 34, digital media reader 36 and bar code reader 38 are each of a type well known to those of ordinary skill in the art and commercially available from well-known manufacturers, such as for example, an Internal Slot Loading DVD/CD ROM from Pioneer, a Pro 9 digital media reader 36 from AtechFlash Technology and an Image Team 3900 bar code reader 38 from Handheld Products. Further details concerning the structure and operation of any of the input devices are not necessary for a complete understanding of the present invention.

Preferably, the workstation 10 further includes a receipt printer 28 which is preferably connected to the computer 22 through a parallel interface connection 30. The receipt printer 28 in the preferred embodiment is an off-the-shelf thermal printer available from a variety of manufacturers, for example a model PPU-231/PHU-131 from Citizen. Further details concerning the structure and operation of the receipt printer 28 are not necessary for a complete understanding of the present invention. The parallel interface connection 30 is also well known in the art and need not be described in further detail for a complete understanding of the present invention. Suffice it to say that the parallel interface connection 30 functions to permit the computer 22 to send suitable print instructions and data to the receipt printer 28 for the printing of receipts and other documentation commensurate with the operation of the workstation 10.

As mentioned above, the preferred embodiment of the workstation 10 includes a touch screen monitor 16, which is preferably, an active matrix color LCD type well known to those of ordinary skill in the art, for example an Elo15″ LCD Touchscreen monitor from Intellitouch. A touch screen is considered to be more user friendly for the user interactions with the workstation 10 than the combination of a keyboard and mouse. The touch screen monitor 16 is employed to: (1) permit a user to input information to the computer 22 for selecting various options for creating the poster and for adding text information to the poster and (2) to display to a user, instructions, prompts and other information to guide the user through the process of creating a poster. The touch screen monitor 16 also displays thumbnails of images for selection by the user and an image of the completed poster. The touch screen monitor 16 is preferably connected to the personal computer 22 through a USB connection 32.

The preferred embodiment of the workstation 10 also includes a standard keyboard and mouse (not shown) connected to the computer 22 by which maintenance of the workstation 10 may be performed by qualified personnel. The keyboard and mouse are located within the housing 12 and are not accessible to a user. Alternatively, the keyboard and/or mouse could be made accessible to the user and used with a conventional monitor screen for inputting user information and text in place of the touch screen monitor 16.

The preferred embodiment of the workstation 10 also includes model CA2015 speakers manufactured by Cyber Acoustics which are used for acknowledging receipt of a touch screen input by the user and for instance, providing oral instructional material to users and to servicing providers. The speakers 48 are driven by a sound card located within the computer 22 over a dedicated audio connection 50 in a manner well known to those skilled in the art.

The workstation 10 further includes an uninterruptible power supply (UPS) 40 which is also connected to the computer 22 through the USB connection 32. The uninterruptible power supply 40 provides power to the personal computer 22, as well as the other subassemblies within the workstation 10 in a manner well known in the art. The uninterruptible power supply 40 is of a type well known to those of ordinary skill in the art, for example, model Back-UPS CS 500 from APC. Further details of the structure and/or operation of the UPS are not necessary for a complete understanding of the present invention.

The workstation 10 also includes a color printer 42 for printing a personalized poster created by a user. In the preferred embodiment, the color printer 42 is a high resolution LED printer of a type well known to those of ordinary skill in the art such as an OKI C9000 series color printer. Other types of color printers could alternatively be employed as long as the printed output colors closely match what is displayed on the monitor 16 and the printer is capable of printing “banner” size paper. A paper feeder 44 is employed for feeding paper or some other media into the color printer 42. Preferably, the paper supply is from a roll included within the housing 12, however a sheet feeder storing sheets of different length paper could be used . The size of the poster to be printed dictates the size of the media fed into the color printer 42 by the paper feed 44. In the preferred embodiment, the size of a poster may be selected by the user to be substantially any value within a range of approximately 5 inches in length to approximately 48 inches in length.

In the preferred embodiment, the color printer 42 obtains printing instructions from the computer 22 through a local area network (LAN). In the preferred embodiment the LAN utilizes signaling conforming to the 100baseT standard. A LAN/modem 46, manufactured by 3Com corporation and known as the Office Connect 56K LAN modem is provided for this purpose. The LAN/modem 46, in addition to establishing the local area network within the workstation 10, is employed for connecting the workstation 10 to a remotely located server (not shown) over the public switched telephone network (PSTN). While the PSTN is preferred for connecting the workstation 10 to the server, other forms of telecommunications media, connected to the workstation 10 by an appropriate modem/telecommunications interface device, could be employed including, for instance, a wide area network, a local area network or a dedicated private line. In this manner, the operation of the workstation 10 may be remotely monitored for problem notifications, and routine and other maintenance functions may be performed under the control of a program at the remotely located server. In addition, new or updated software may be remotely loaded onto the computer 22 from the remote server. Further, new photo gallery images or new poster templates may be loaded into the computer 22 from the remote server. Other uses of the LAN/modem 46 for remotely enhancing or monitoring the operation of the workstation 10 will be apparent to those of ordinary skill in the art.

As noted above, substantially all of the subassemblies or hardware components of the preferred embodiment of the workstation 10 are comprised of readily available, off the shelf, commercially available products well known to those of ordinary skill in the art. Also, the subassemblies or components of the preferred embodiment are connected or interfaced to the computer 22 as described above. However, other means for interconnecting the components or subassemblies could be used, such as for instance, connecting the personal input devices to the LAN, and still be within the spirit and scope of the invention. Further, while the preferred embodiment uses the bar code reader 38 and the receipt printer 28, it is contemplated that alternate embodiments would not use one or the other, or either of the bar code reader 38 and the receipt printer 28.

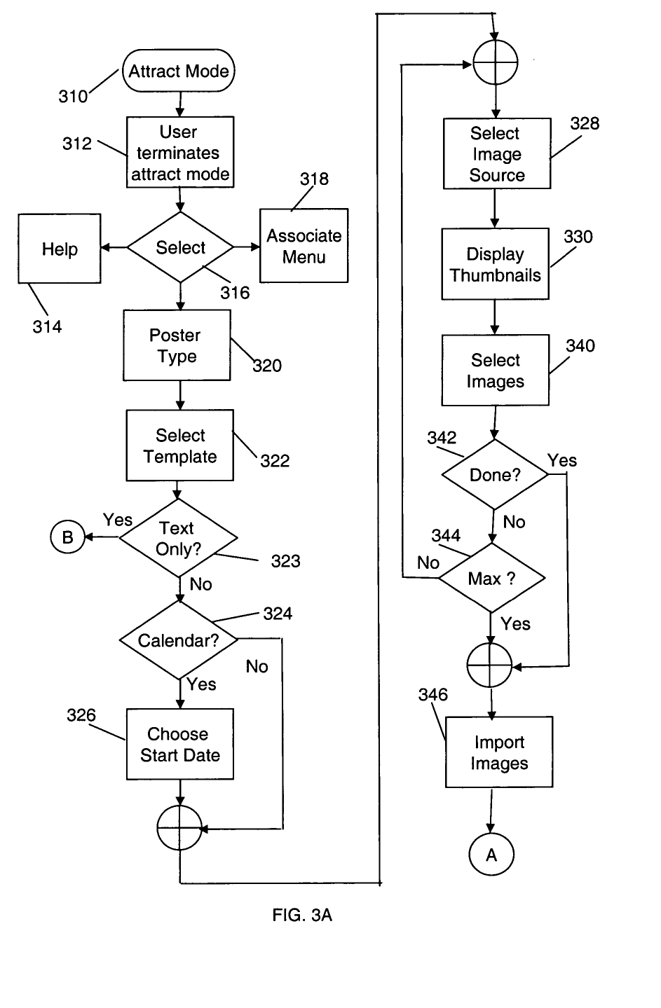

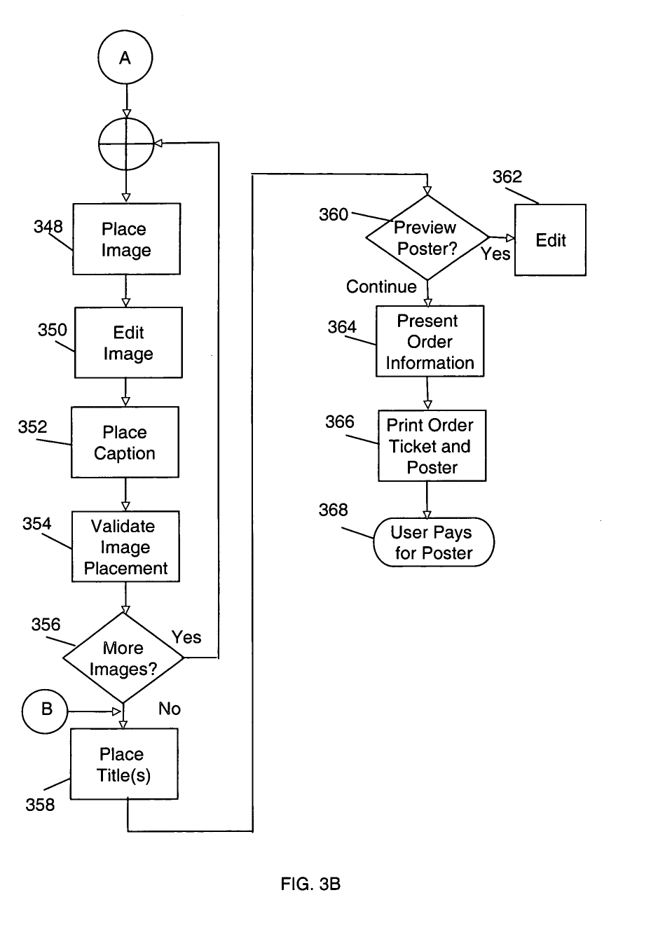

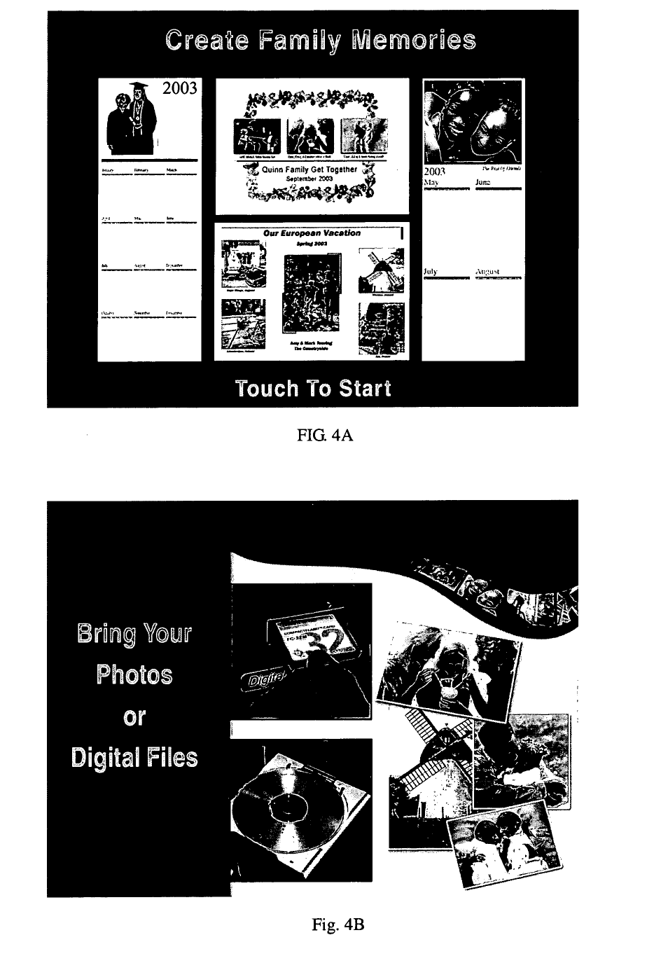

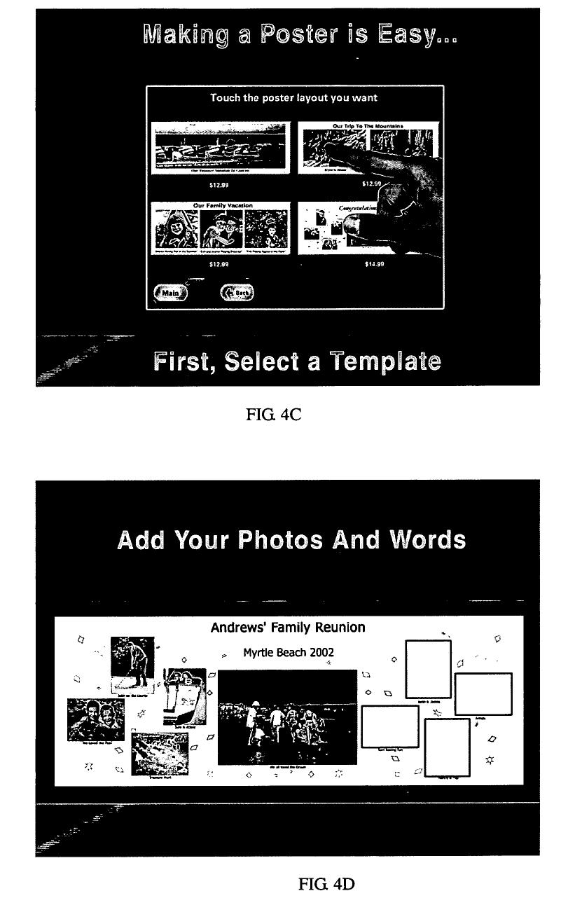

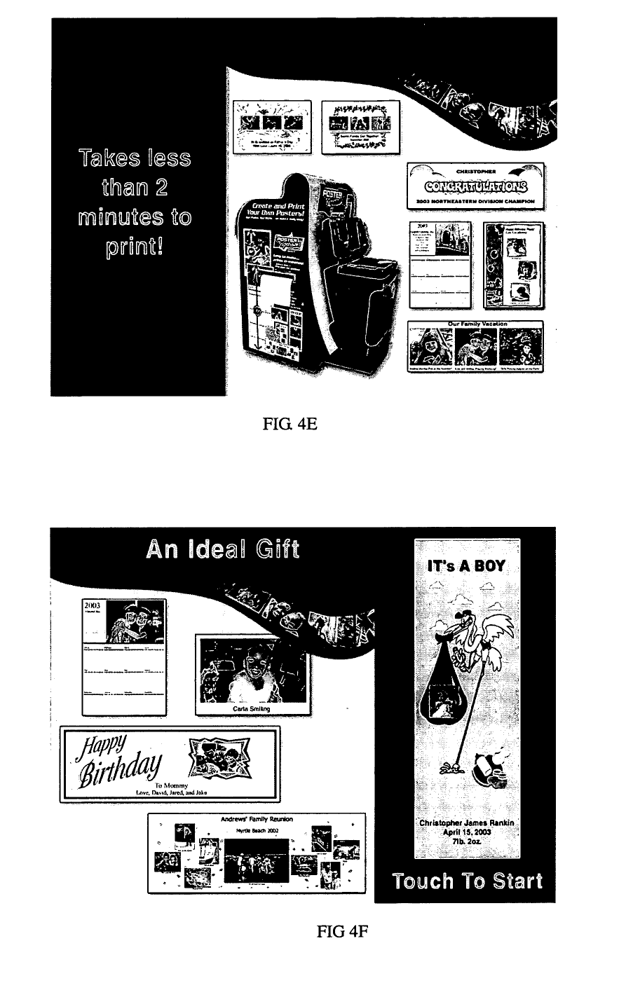

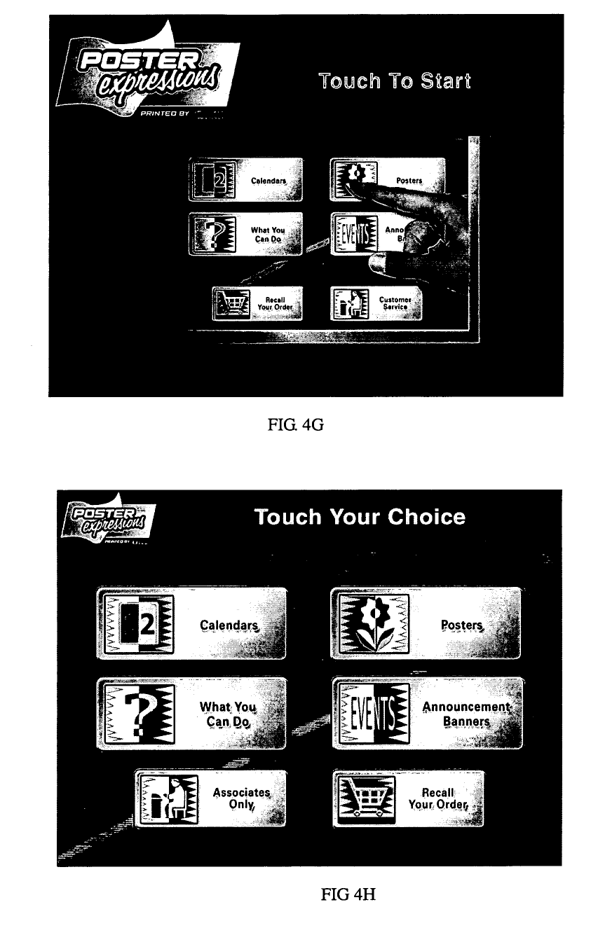

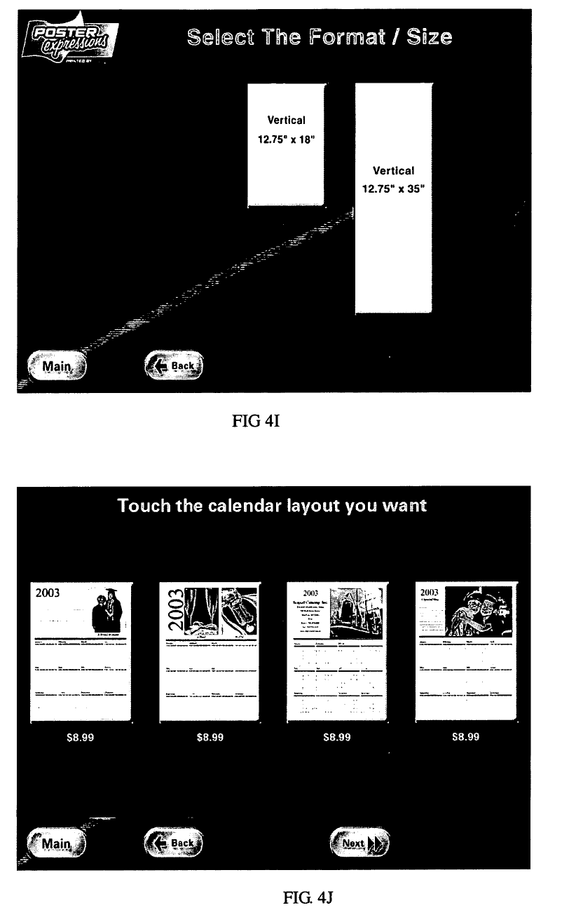

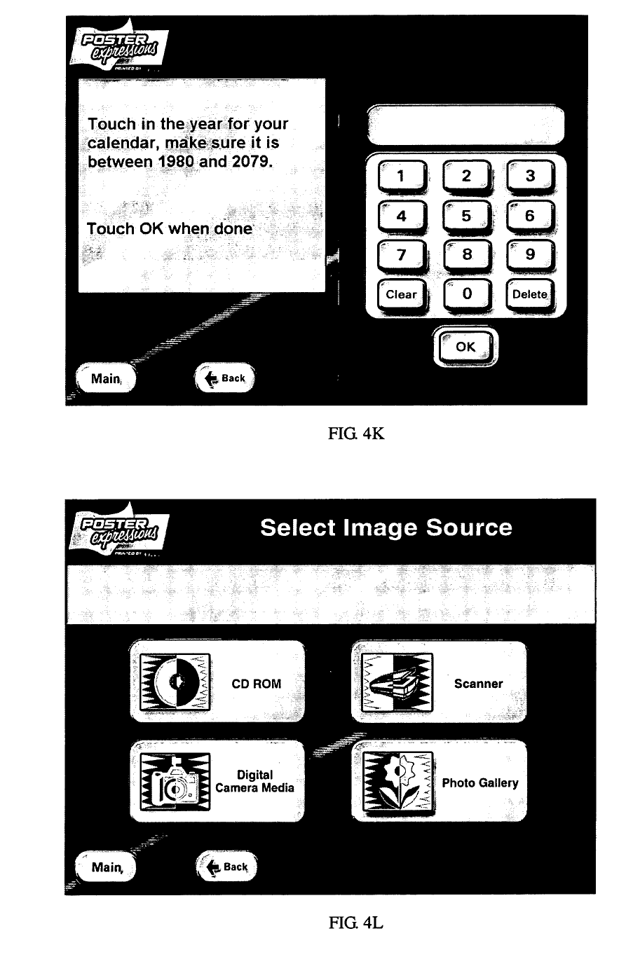

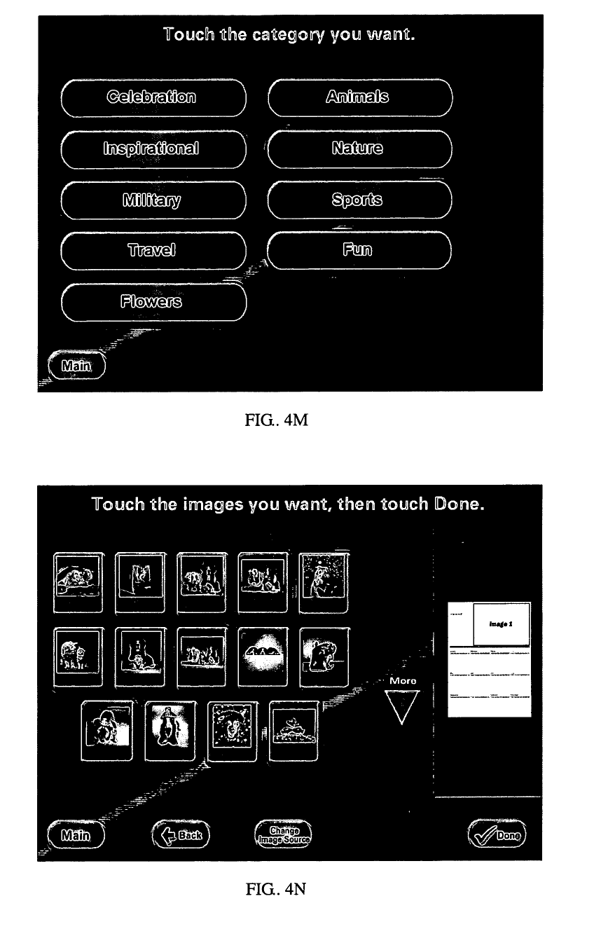

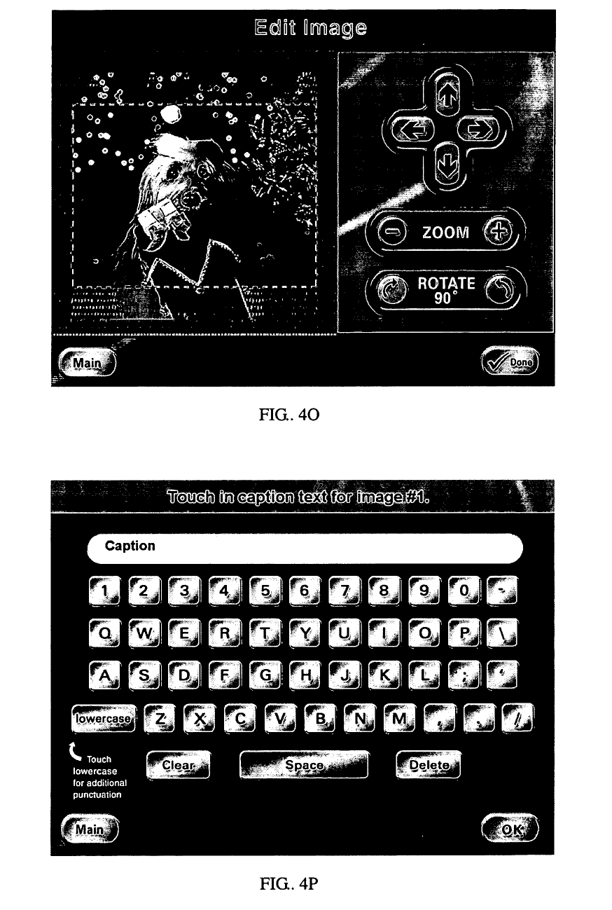

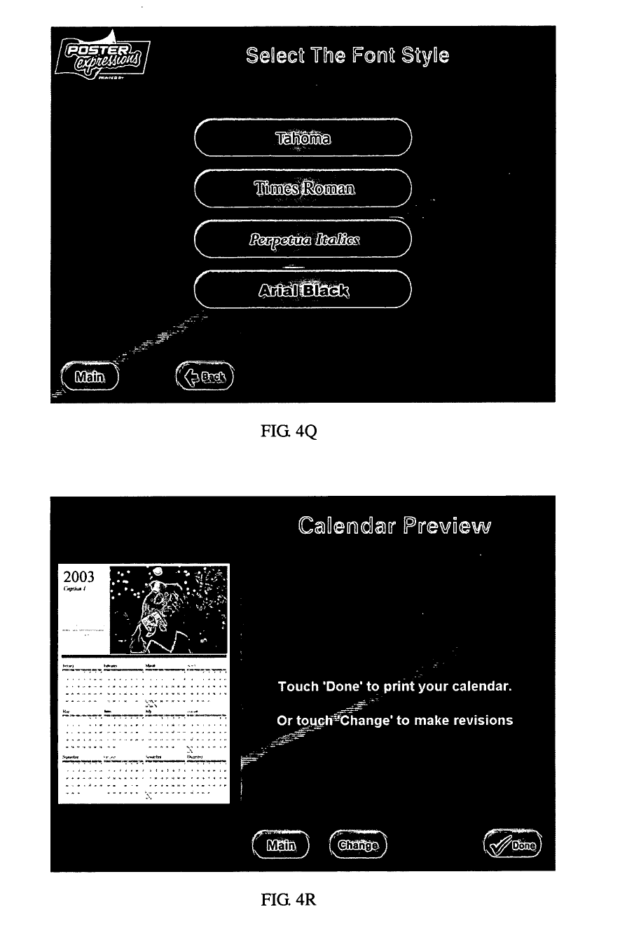

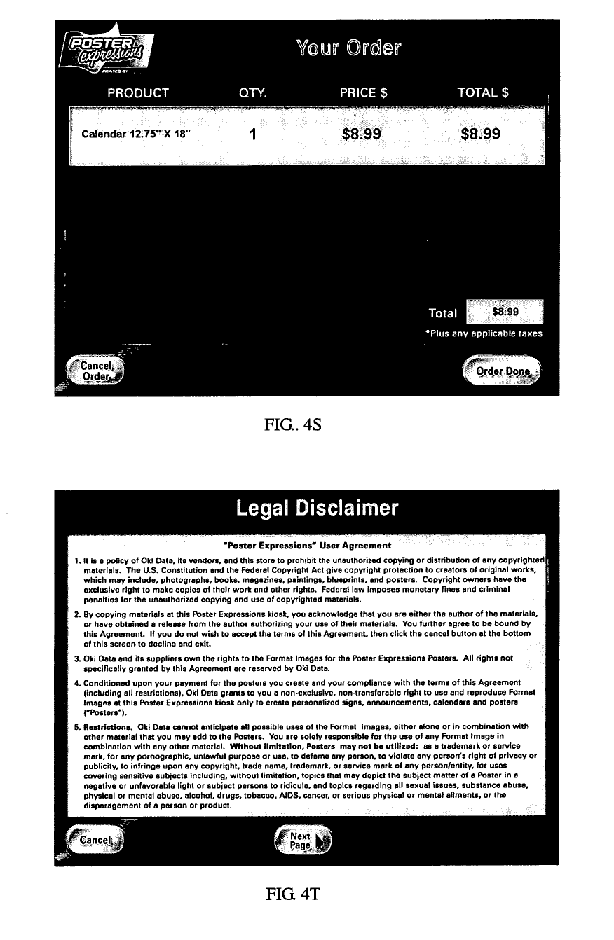

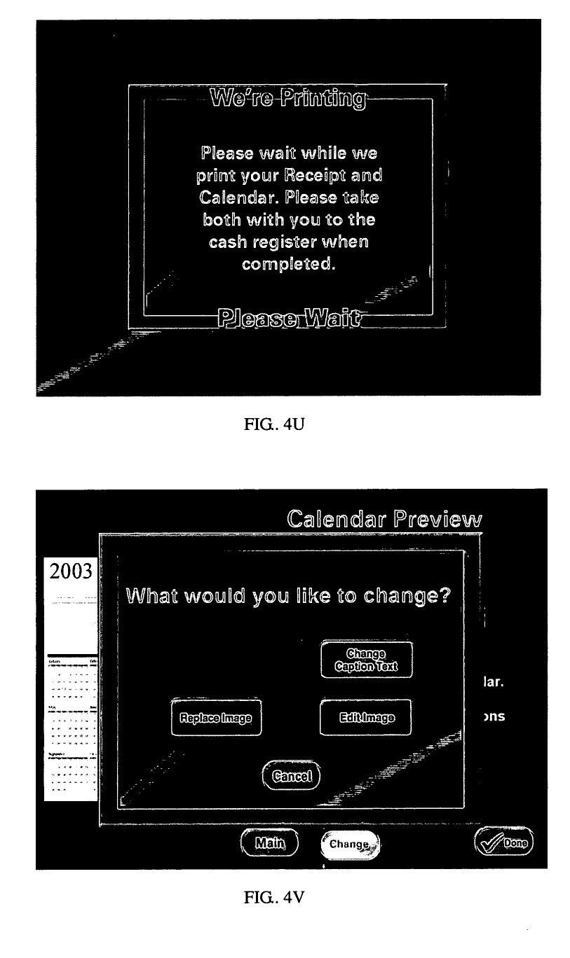

FIGS. 3A and 3B provide an overview of the process followed in creating a personalized poster. When the kiosk workstation 10 is idle without a user generating or printing a poster, the workstation is in an attract mode (step 310), with information, sample posters, etc., being cyclically displayed on the touch screen monitor 16 to attract potential users to the workstation 10. Examples of attract mode display screens are set forth on FIGS. 4A-4G. When the workstation 10 is in the attract mode, a “touch to start” message is displayed in a prominent area on at least one of the attract mode display screens on the touch screen monitor 16. A user wishing to generate a poster initially touches the screen (step 312) to initiate the poster creation process. Touching the screen causes the workstation 10 to exit the attract mode and display on the monitor 16 a first menu screen, an example of which is shown on FIG. 4H, setting forth a choice of the types of possible posters which may be produced. The choice of possible posters may include a calendar, an event poster, an announcement banner etc. The first menu screen may also include a “help” or “what you can do” button which, if touched by a user, will display a separate “help” menu 314 (not shown). The first menu screen may also include a touch button which when selected will display an associate menu 318 (not shown) to provide additional administrative functions that allows the retailer to change certain operating characteristics of the workstation 10, and a recall button which allows the user to print a poster which had been previously created. If a particular type of poster is selected (step 320), the user is requested to select a template from a second menu screen for the selected type of poster (step 322). The selected template may be a template which provides for inserting images from one or more of the image sources or may be a template which does not provide for inserting images, i.e. a text only template. Selection of the template includes selecting the size and the orientation (i.e. horizontal or vertical) of the poster (FIG. 4I) and the format of the poster (e.g. the number of images to be included (if any) and placement of the images). For example, if a calendar is selected (step 324), the user selects (FIG. 4J) whether it should be a vertical calendar or a horizontal calendar, whether images should be presented at the top, bottom or elsewhere, etc. Following selection of the calendar format, the user is prompted at step 326 to select the year for which the calendar is to be printed (FIG. 4K). The workstation 10 then generates the proper day/month relationships for the selected year.

If a text only template (i.e. a template not providing for images to be inserted from an image source) is selected at step 323, the user is prompted to place one or more titles at predetermined portions of the selected template (step 358). If a template providing for inserted images is selected, the user is prompted to select one or more of the sources of the image or images for the poster (step 328 and FIG. 4L). In the preferred embodiment, the user may select from the CD ROM 34, the scanner 26, or the media reader 36 personal input devices for inputting personal images to the workstation 10. All of the images input from an individual personal input device are displayed as thumbnails on the monitor 16 (step 330 and FIG. 4N). The user is prompted to select one or more images from the displayed thumbnails (step 340), by touching the thumbnails, for inclusion in the poster. The user may also select (step 328) images from a “photo gallery” stored within the workstation. If the “photo gallery” button is selected, the user is presented with a screen for selecting photos from a variety of categories (FIG. 4M). The selection of images from the different image sources continues until the user indicates “done” (step 342) or the predetermined maximum number of images have been selected (step 344), at which time the selected images are imported and stored in the memory of the workstation 10 (step 346). Starting at step 348, each selected image is placed at the desired location within the selected template. At step 350, the user is prompted to edit the placed image. The user may zoom, crop, move and rotate the placed image. (FIG. 4O). Upon completion of the editing, the user is prompted to place a text caption for the placed image (step 352). The touch screens shown in FIGS. 4P (a representation of a keyboard) and 4Q are provided for the purpose of inputting the caption and selecting the font of the caption. The user is then asked to validate the correct placement editing and caption of the image (step 354). The image placement, editing and validation loop continues until the entire template has been filled with the selected images. The user then places a text title at the appropriate location within the template (step 358) using the touch screen display shown in FIG. 4P, and a preview of the created poster is displayed on the touch screen monitor 16 (step 360 and FIG. 4R). The user is prompted (FIG. 4V) to either edit the previewed poster (step 362) or validate that the poster, as created, is correct. At step 364, the order information and legal disclaimer are presented to the user (FIGS. 4S and 4T). If the user accepts the order information, at step 366, a payment instruction screen (FIG. 4U) is displayed by the monitor 16, an order ticket is printed by the receipt printer 28, an output signal representative of the poster is transmitted from the computer 22 to the color printer 42 and the poster is printed by the color printer 42. Thereafter the user removes the order ticket and the poster from the workstation 10 through the output slot 20 and pays an attendant for the poster at step 368.

It should be apparent to those of ordinary skill in the art that similar monitor screens could be displayed to users in connection with the creation of posters other than the ones specifically illustrated in connection with FIGS. 4A-4V.

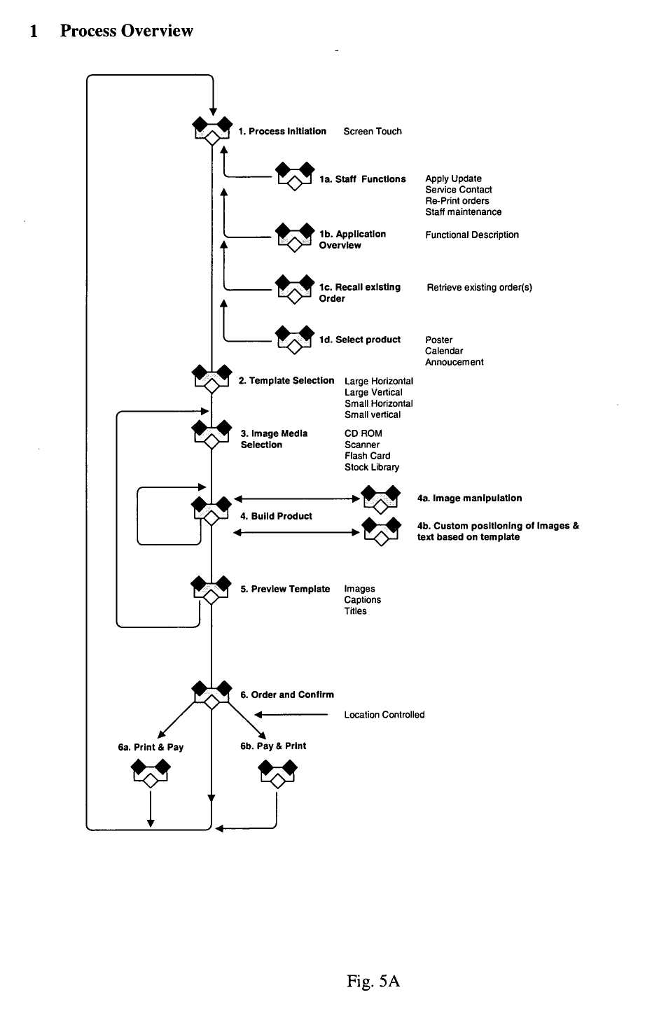

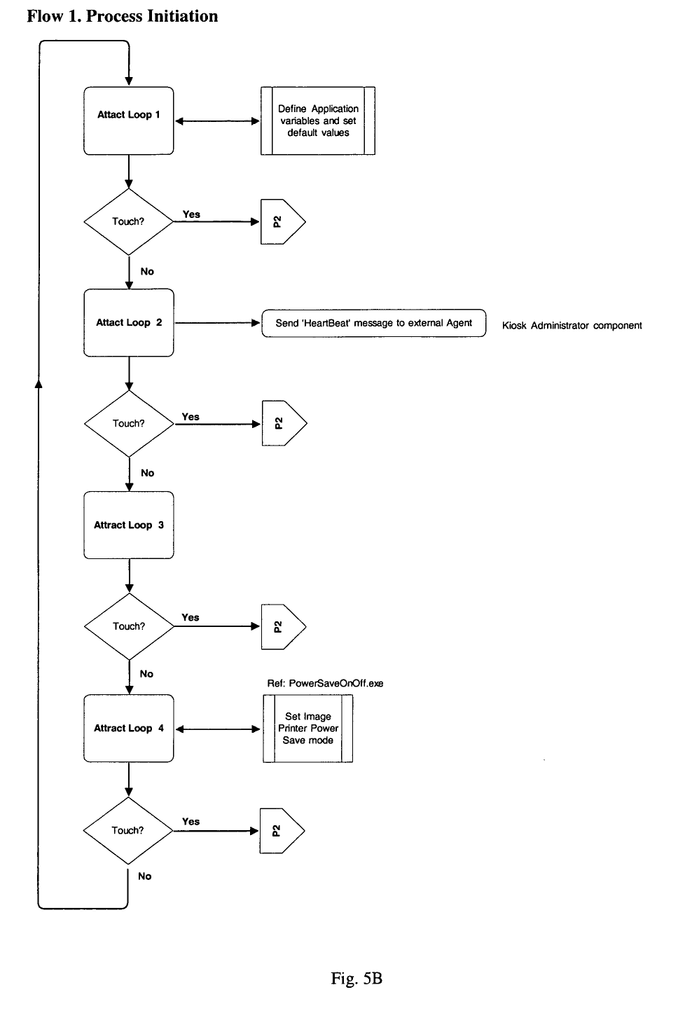

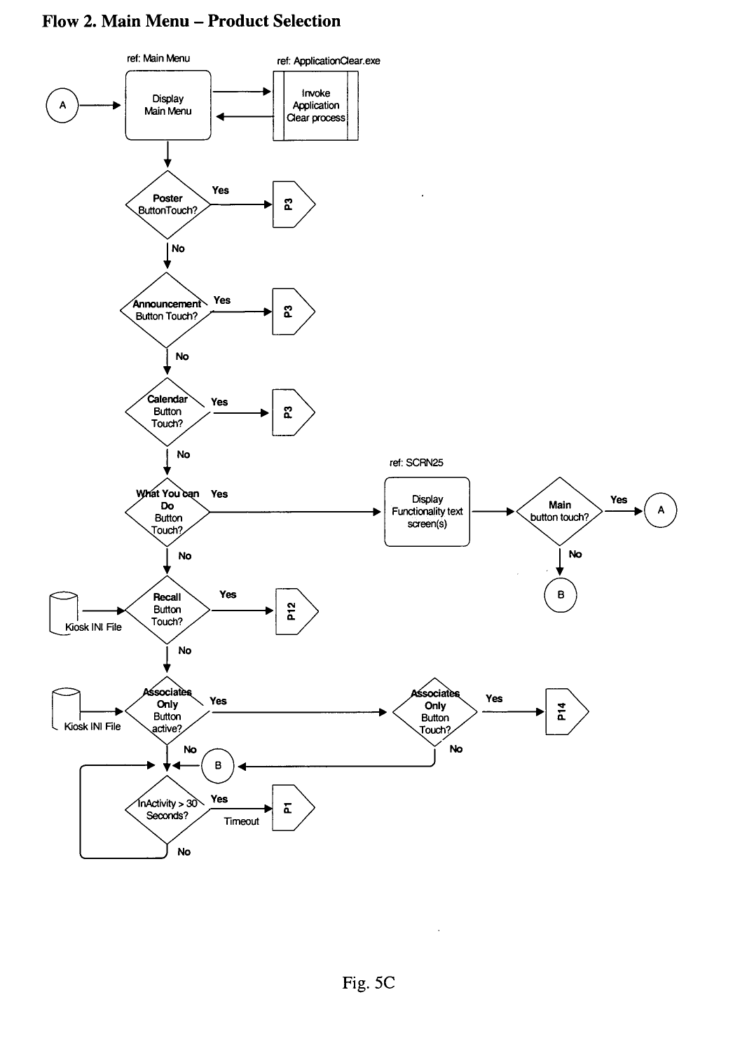

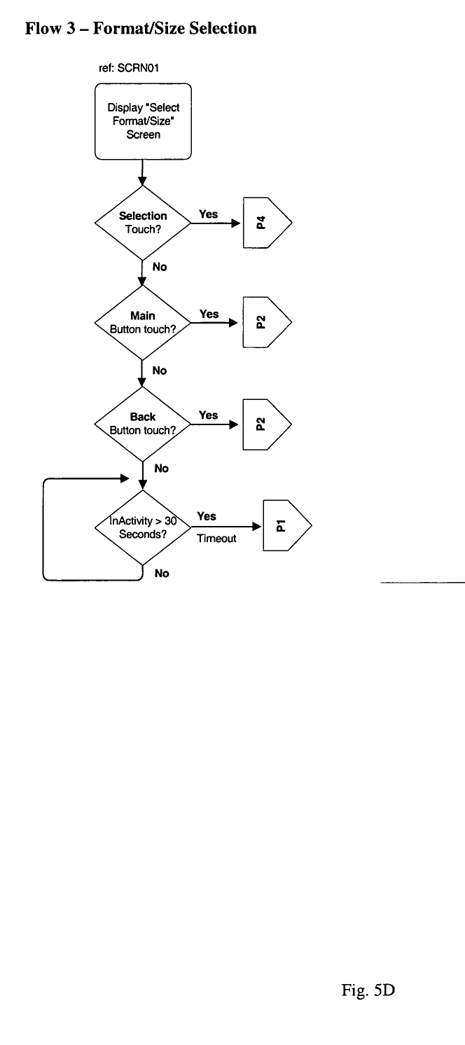

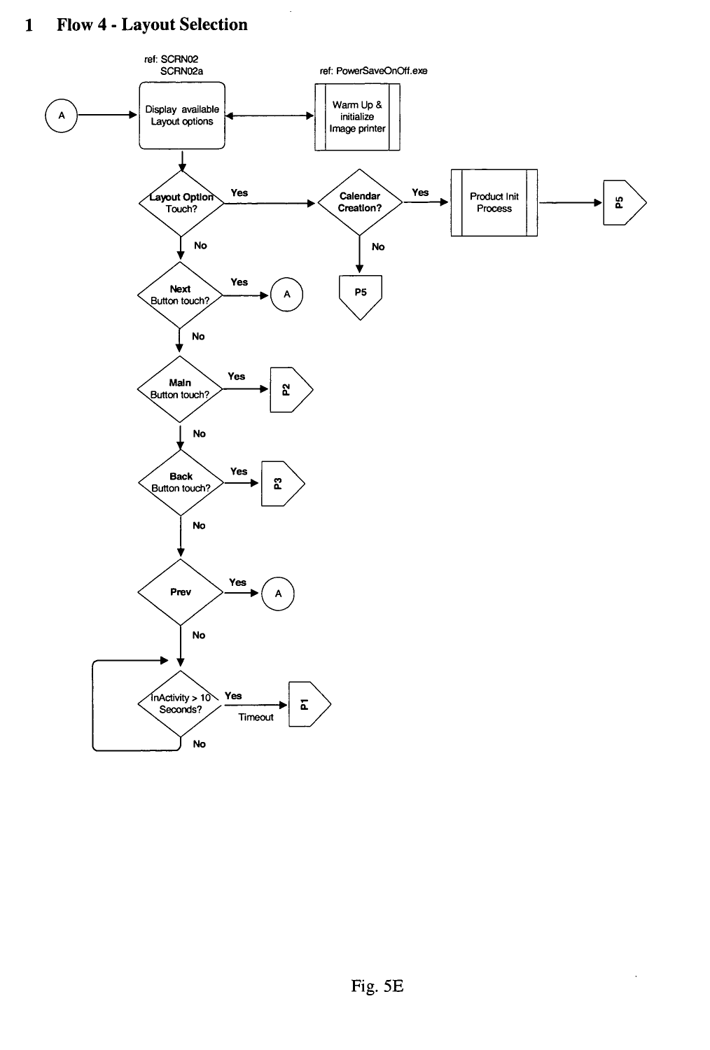

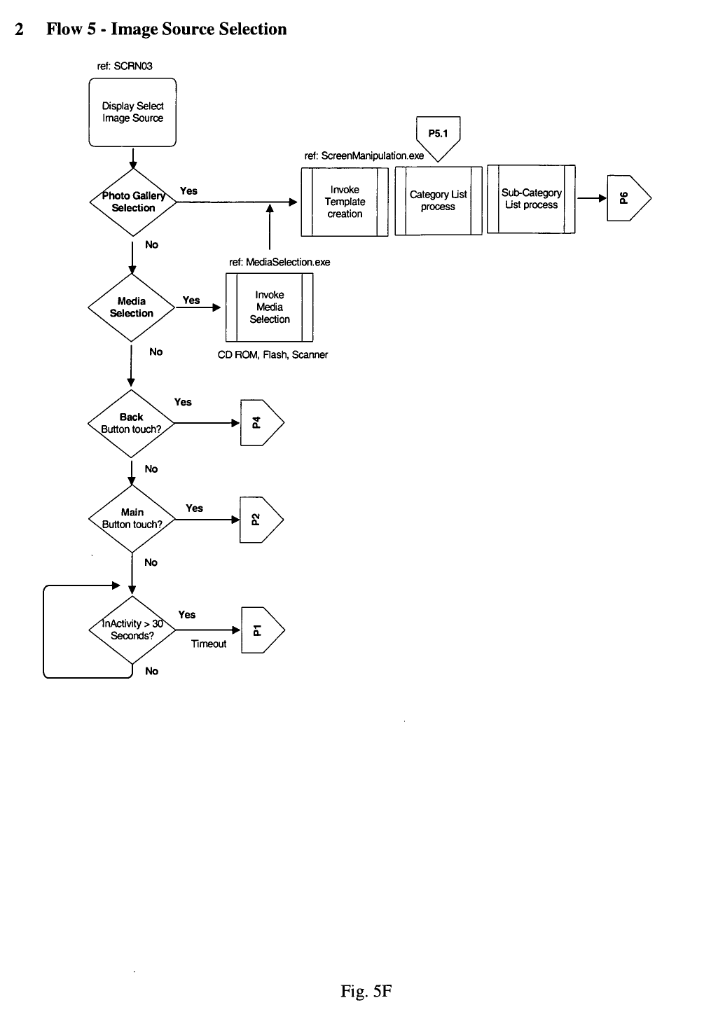

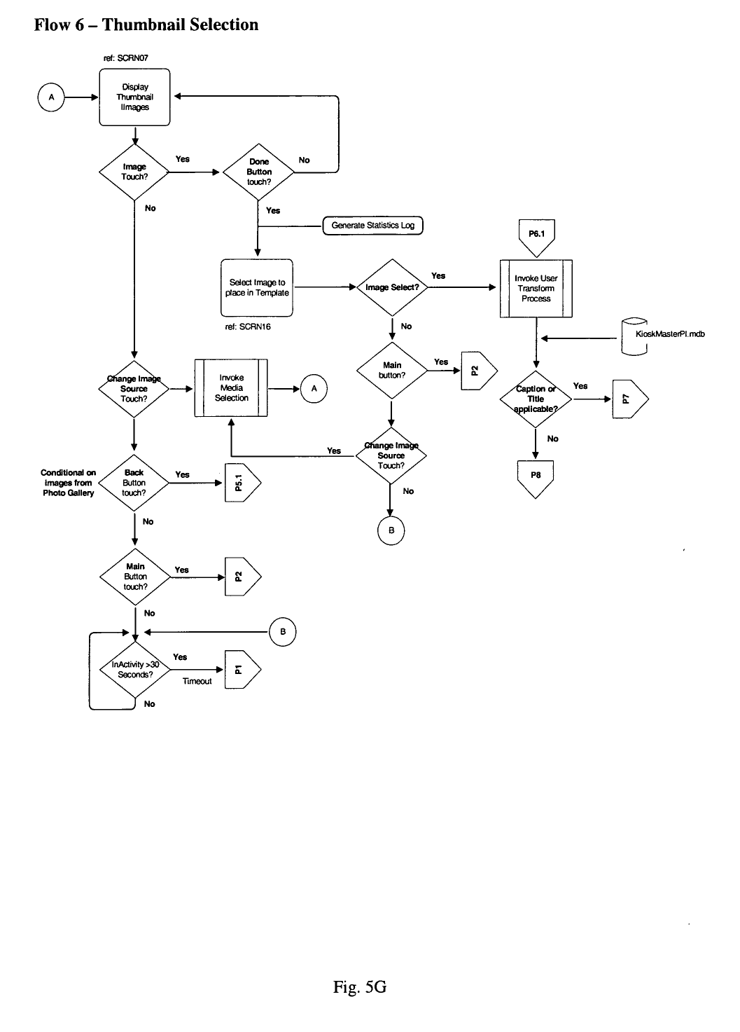

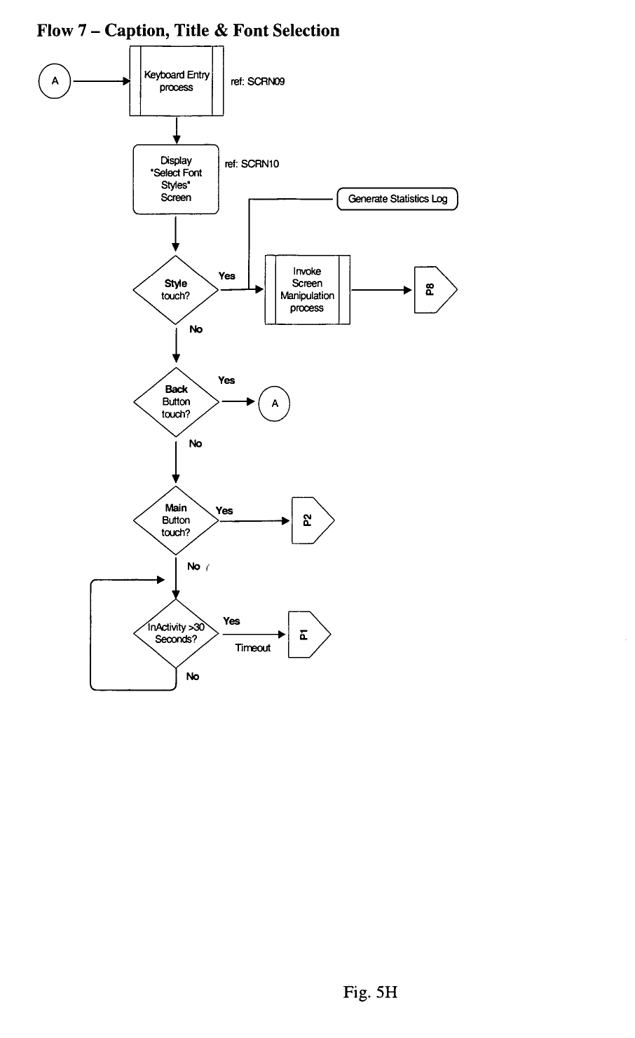

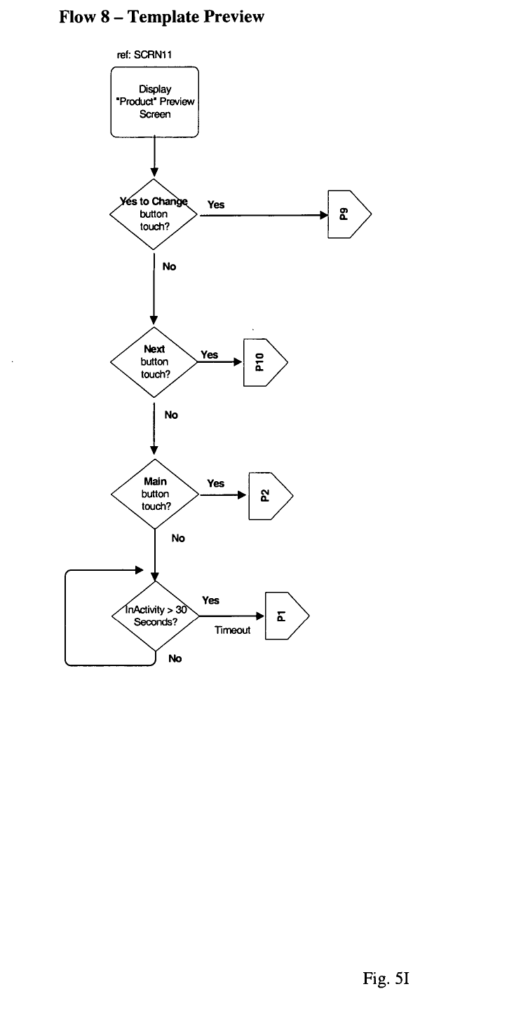

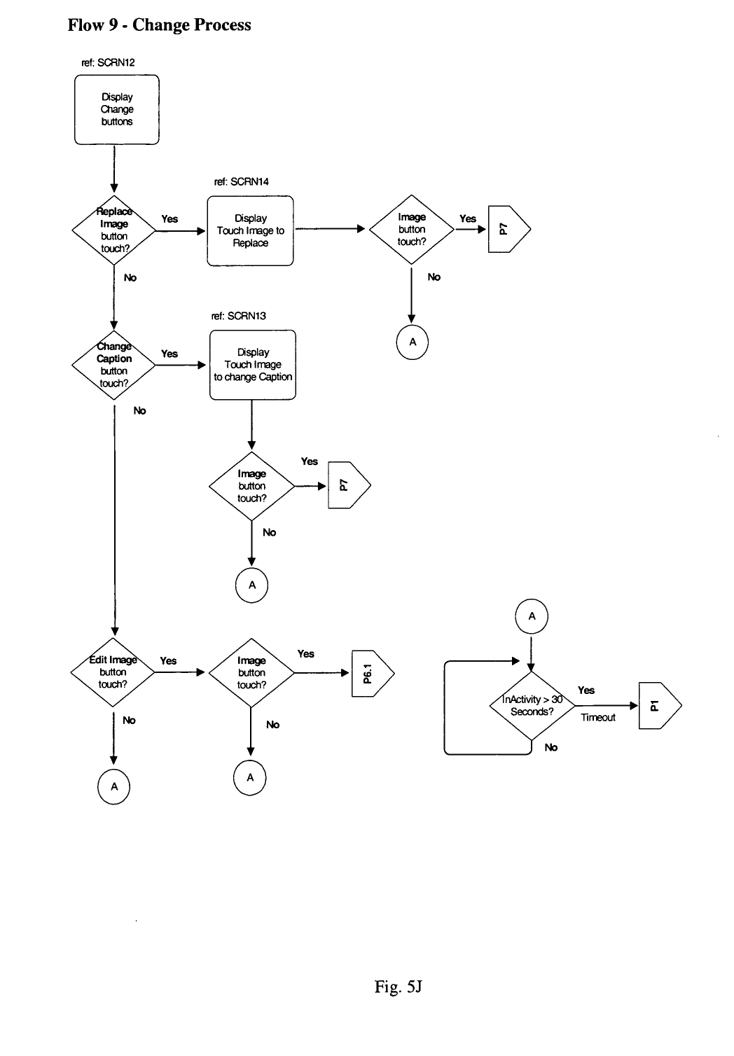

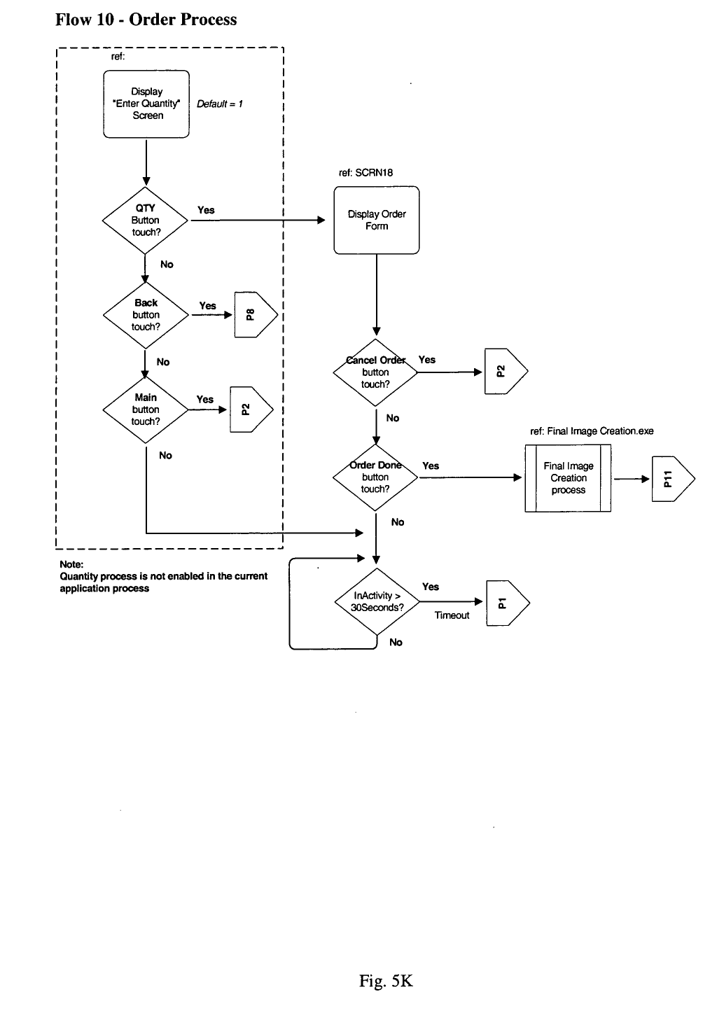

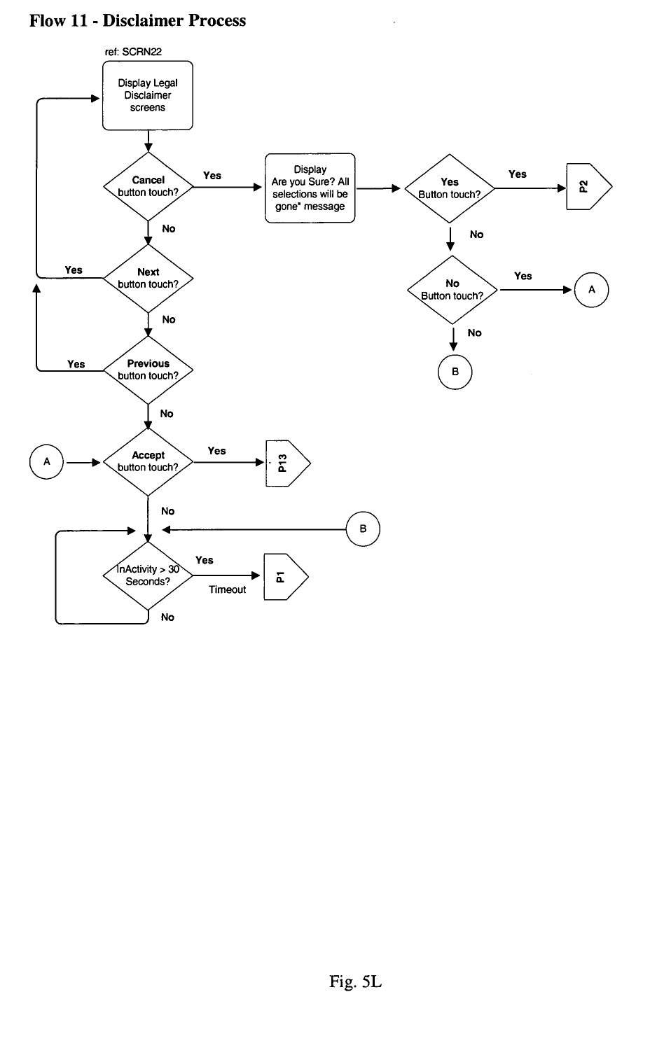

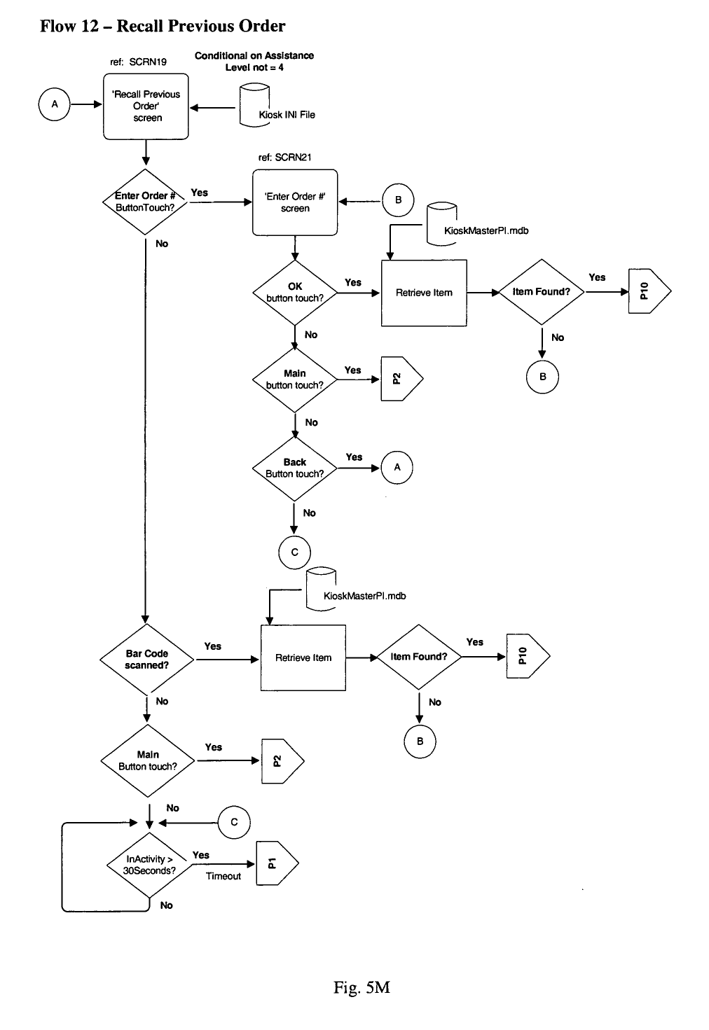

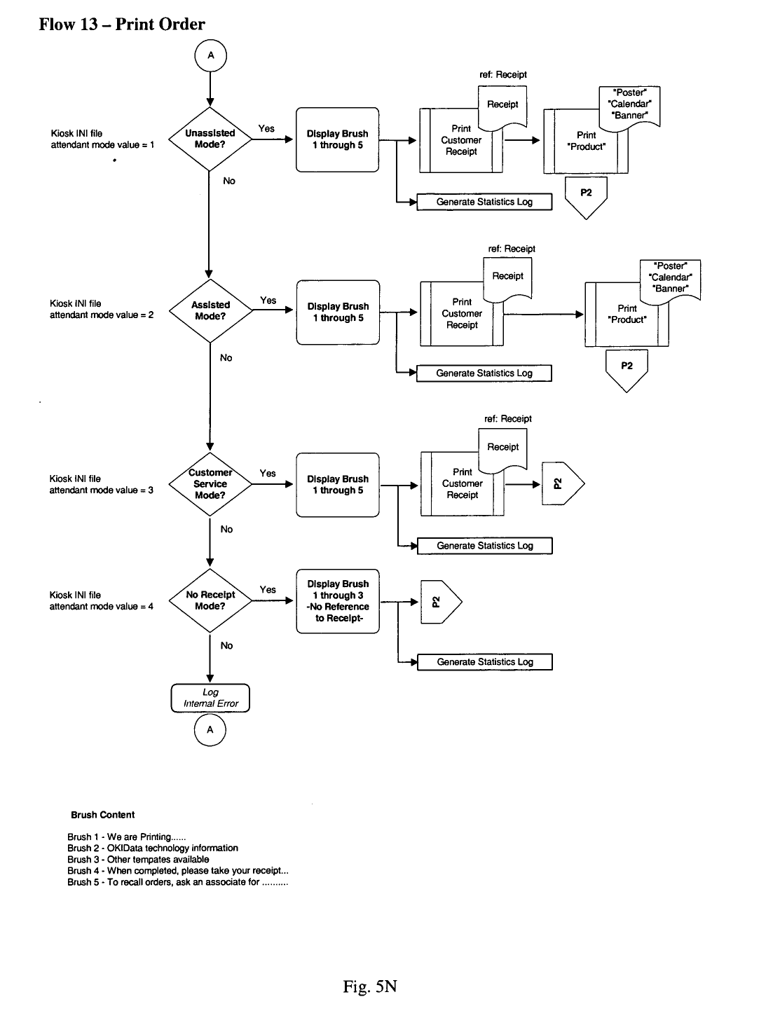

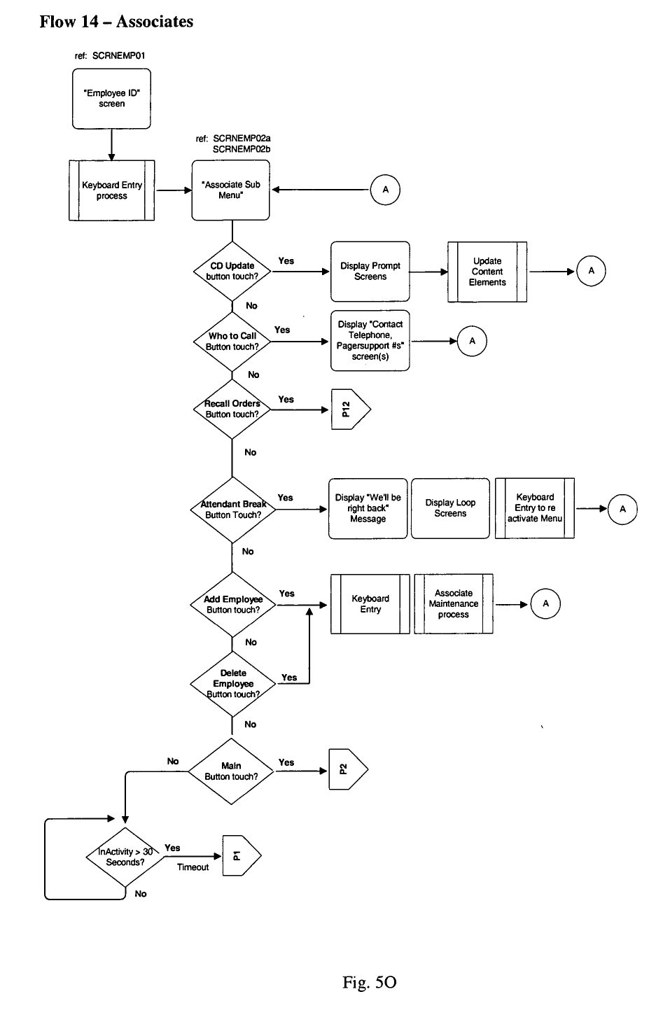

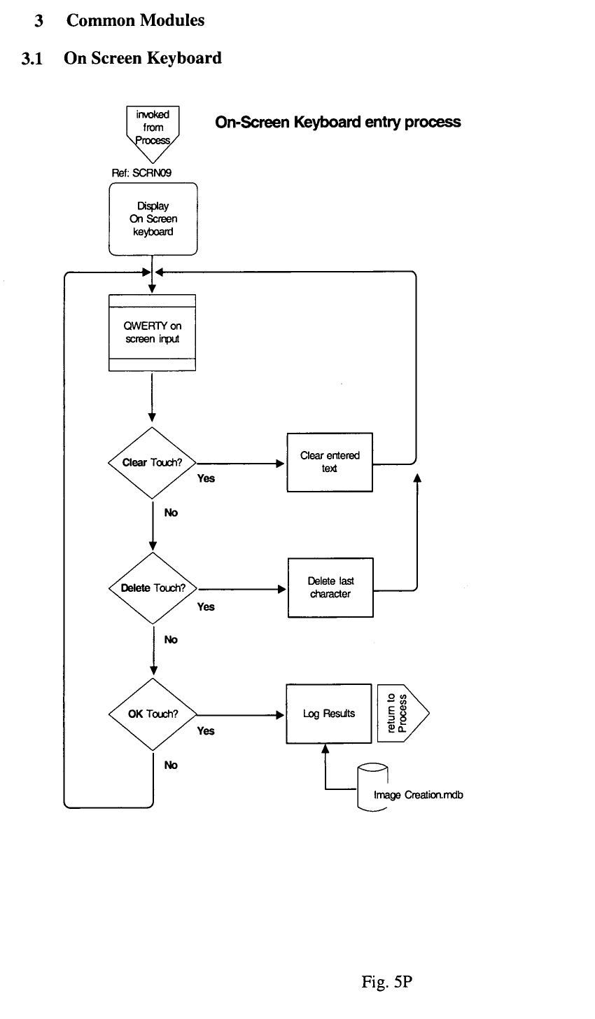

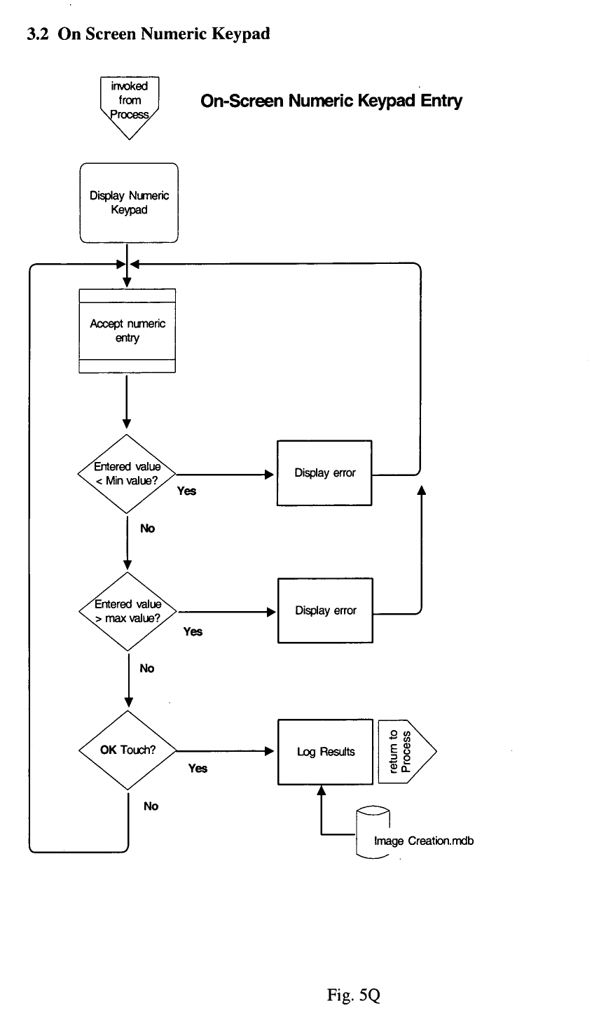

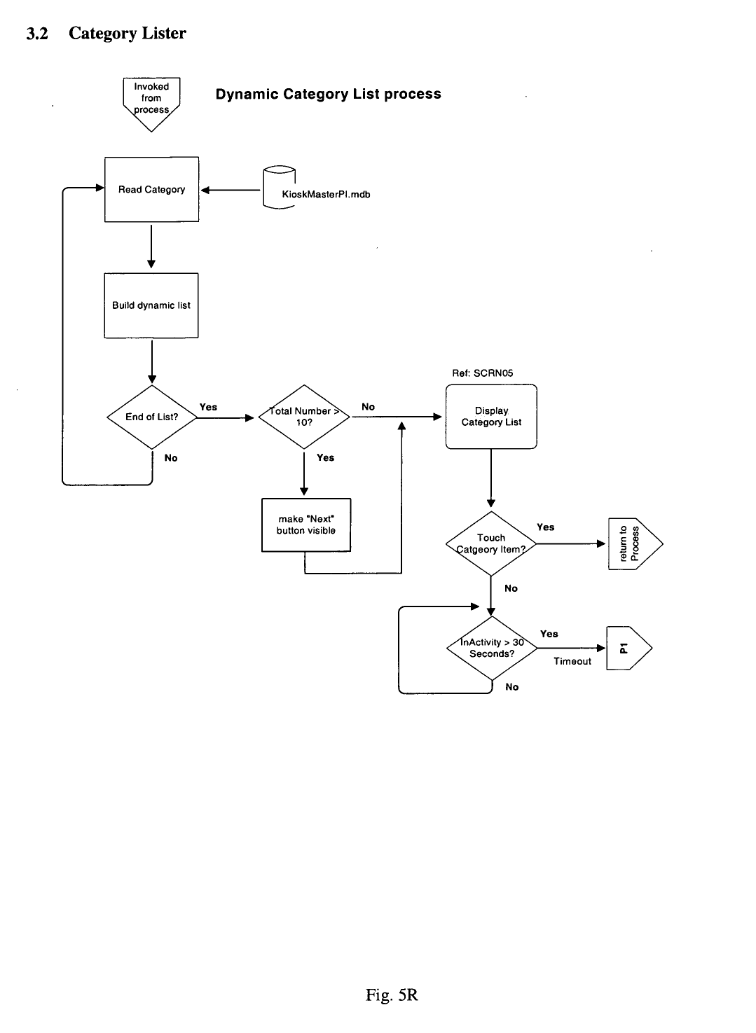

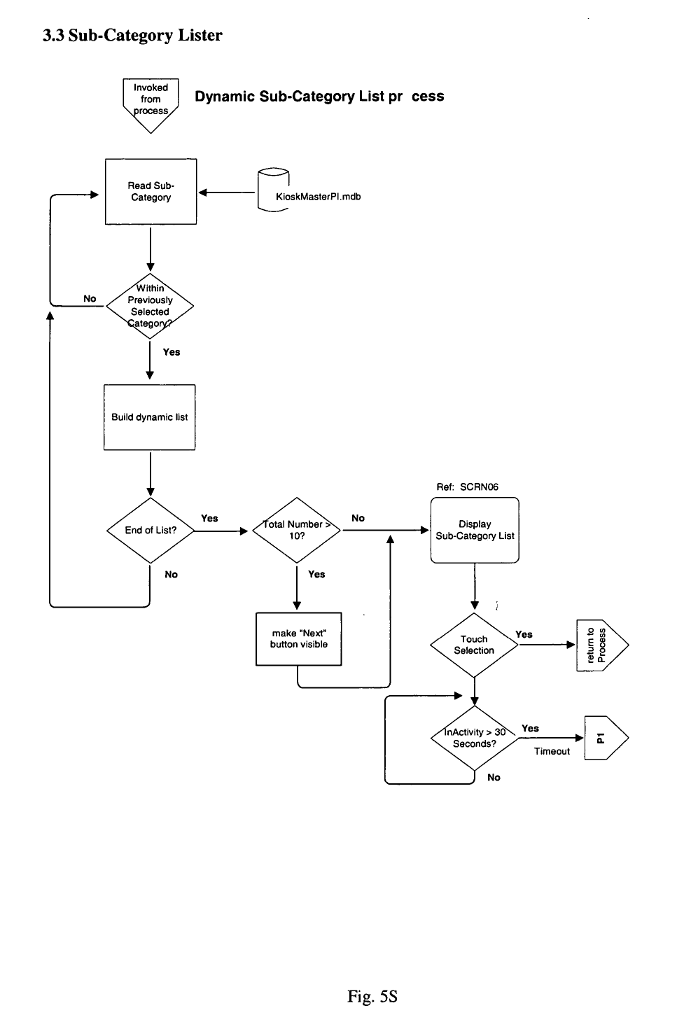

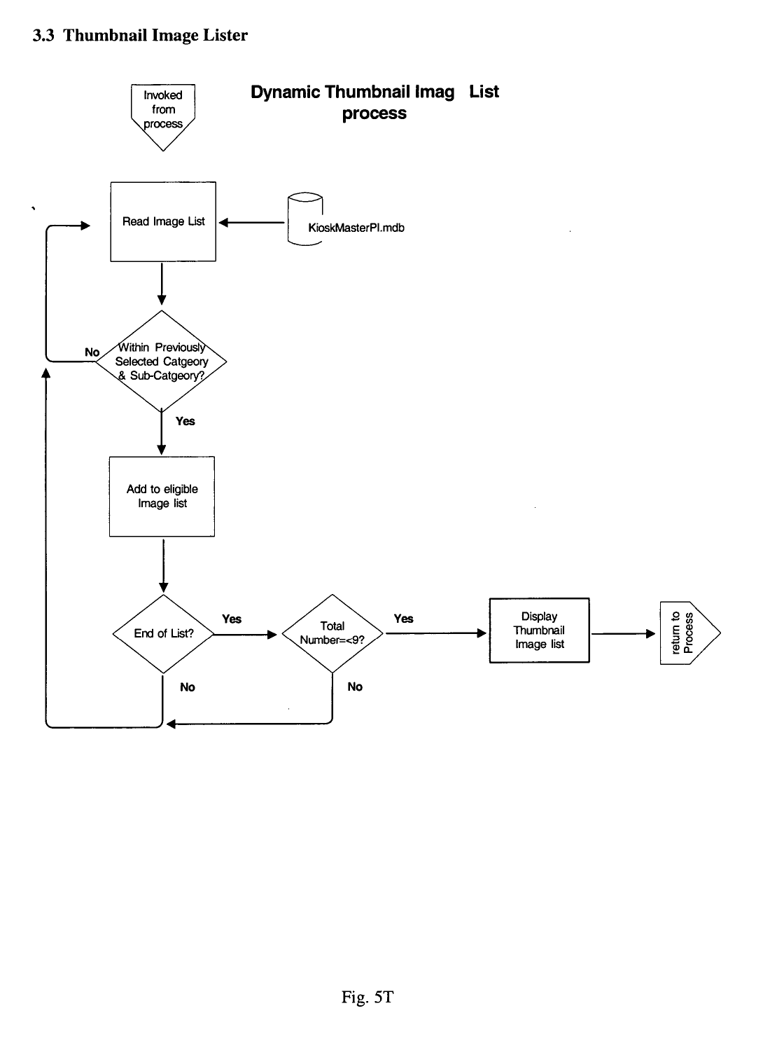

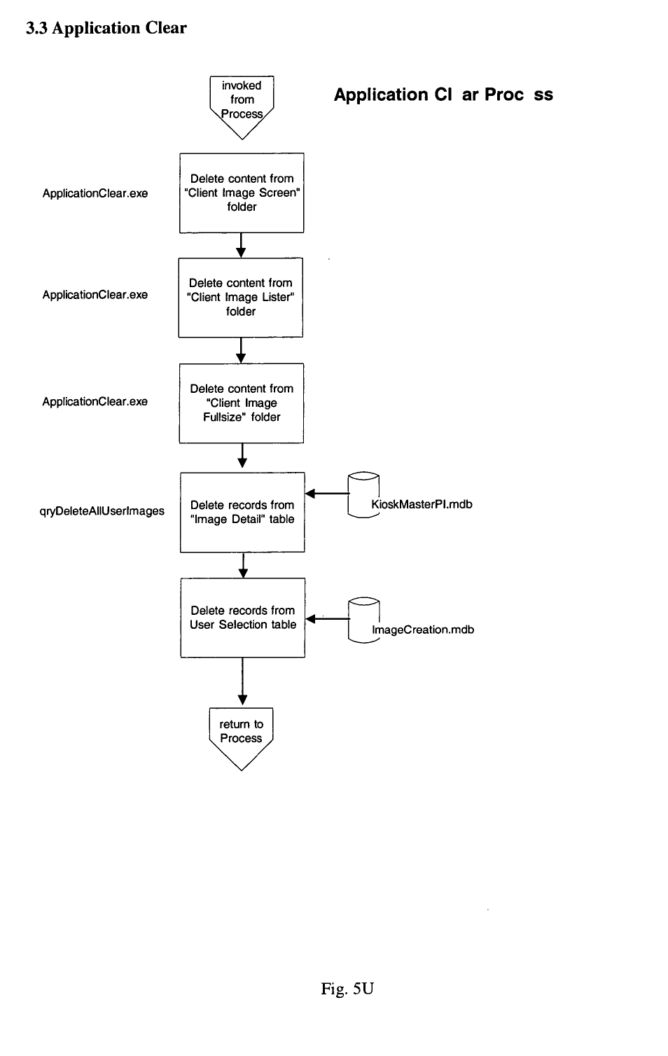

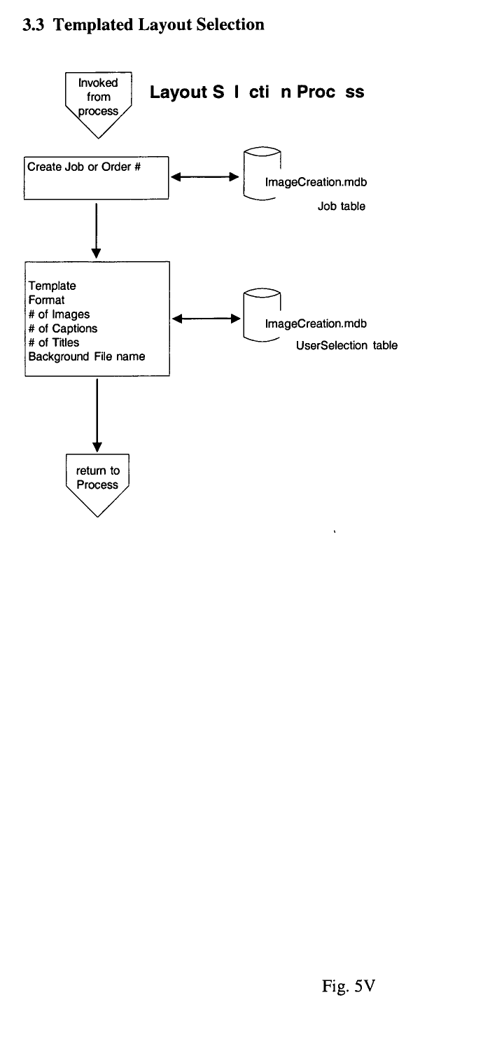

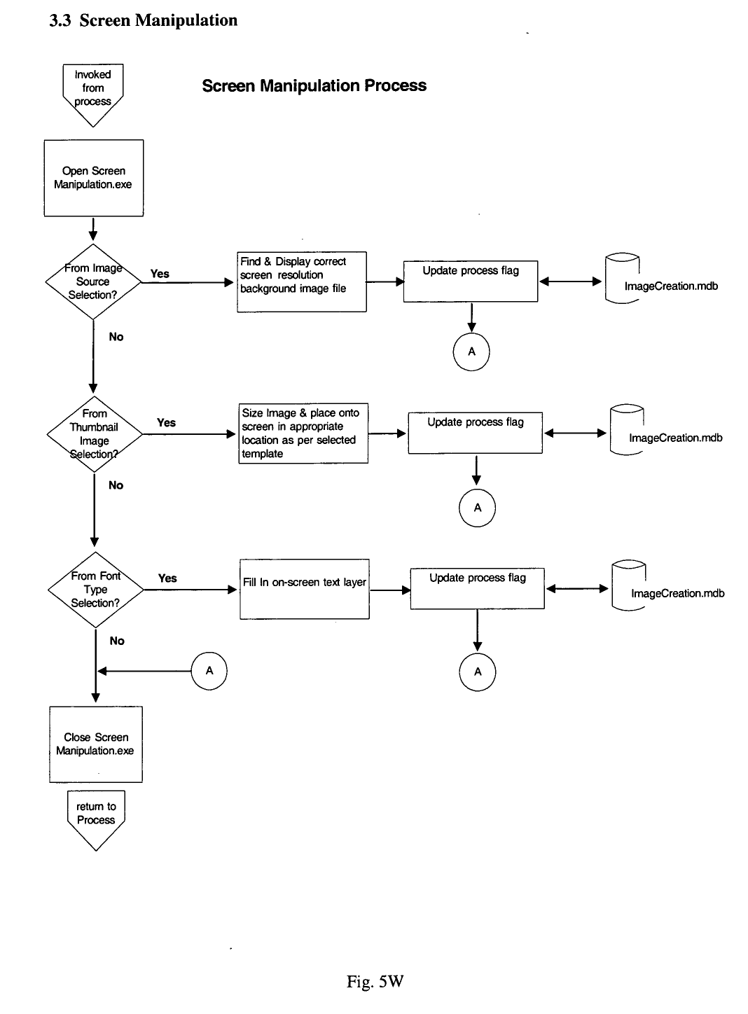

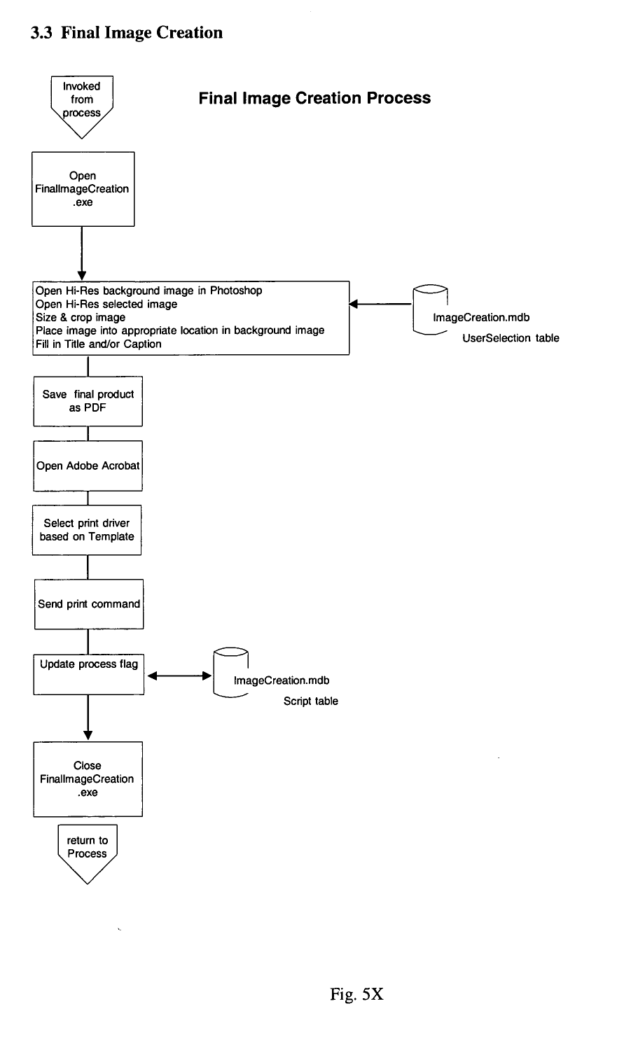

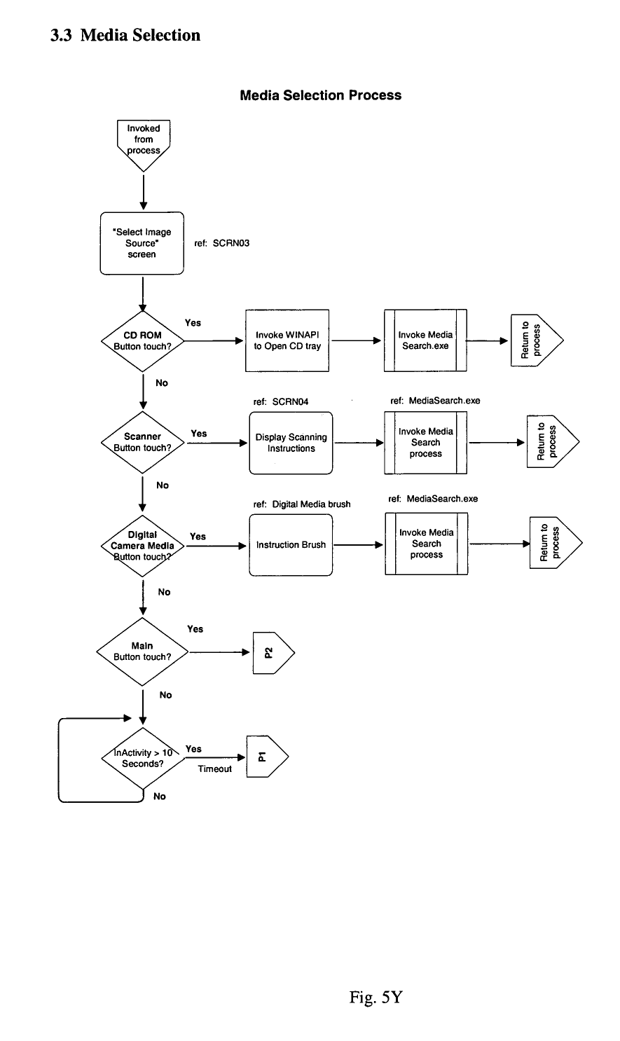

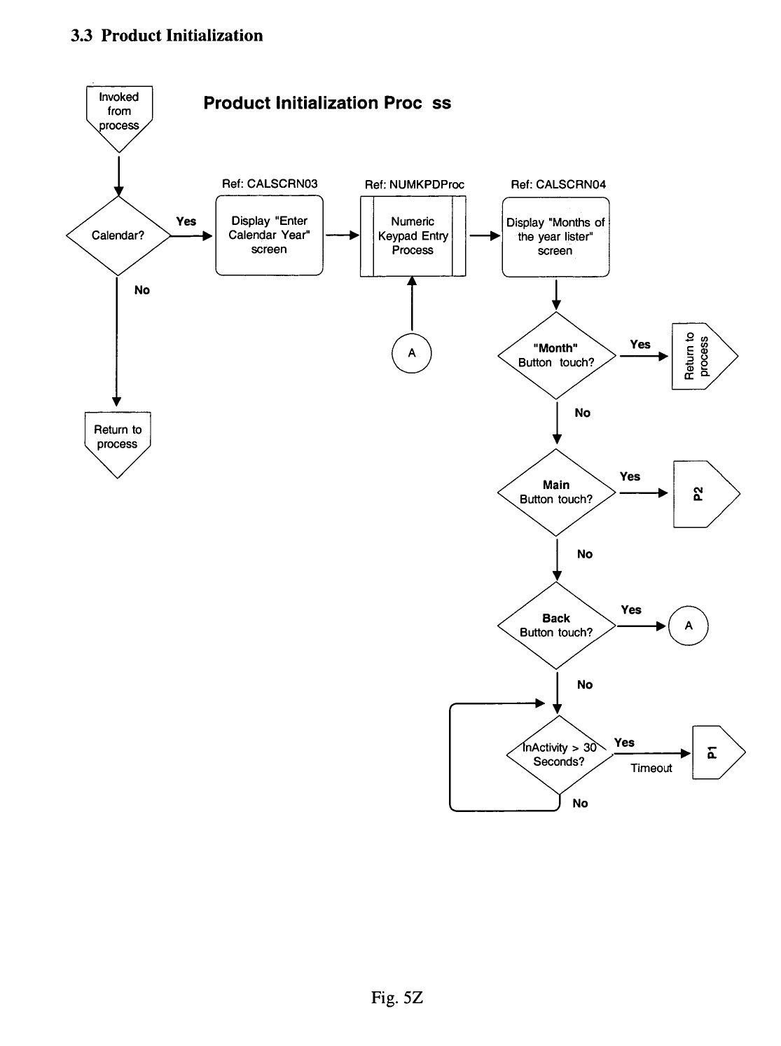

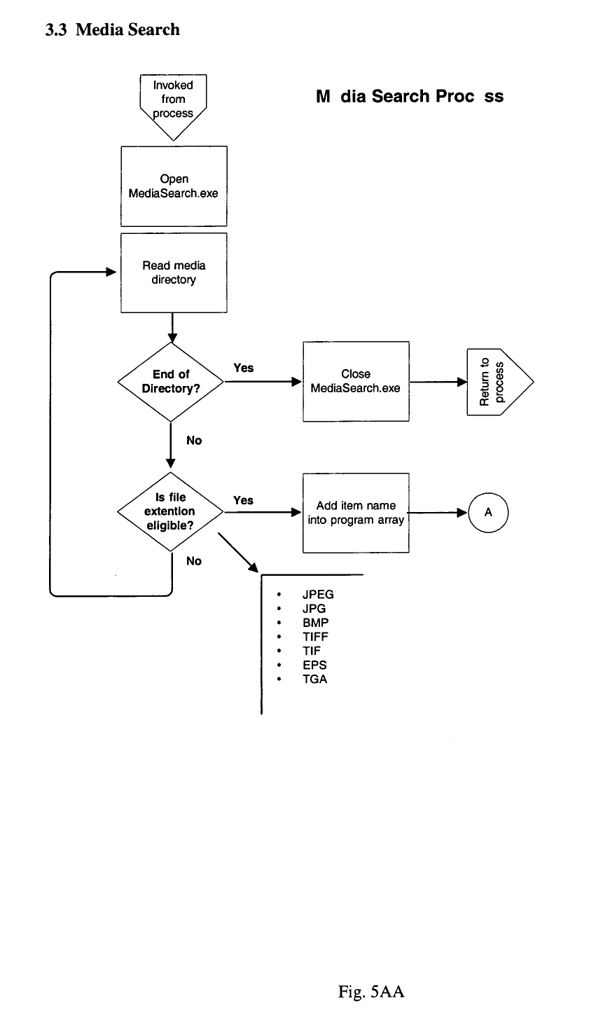

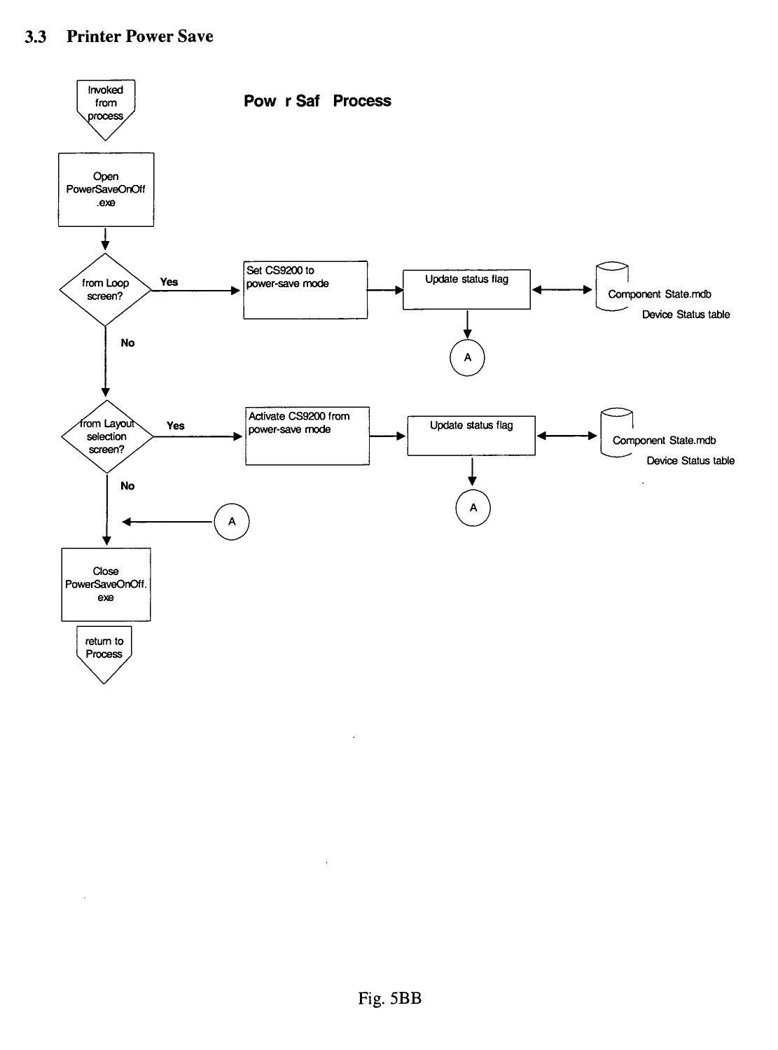

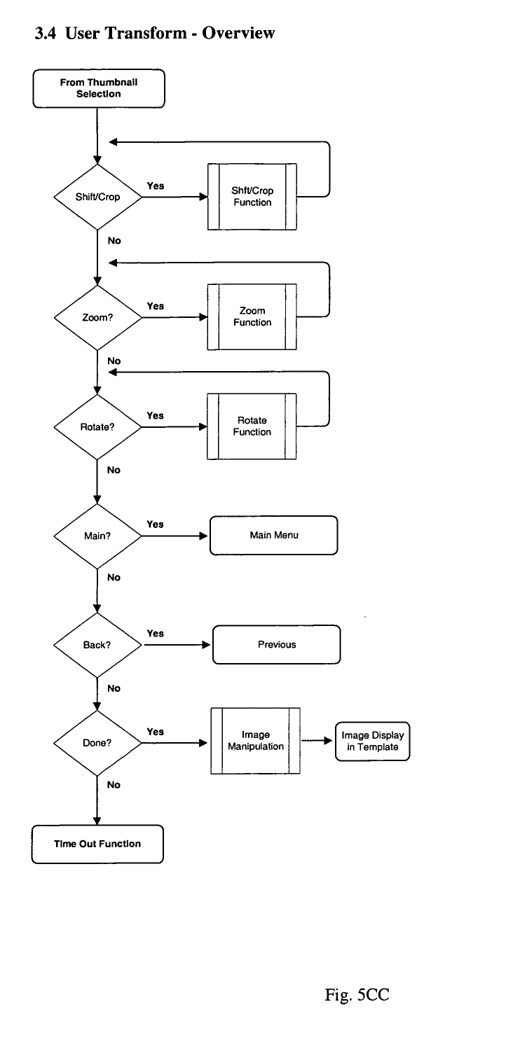

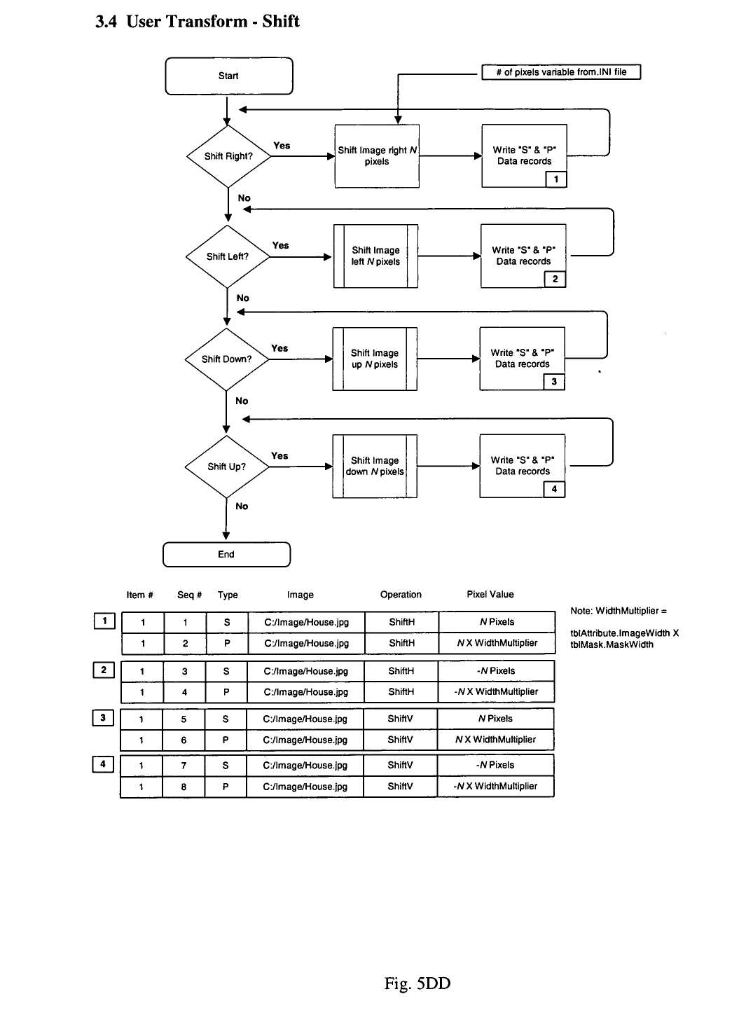

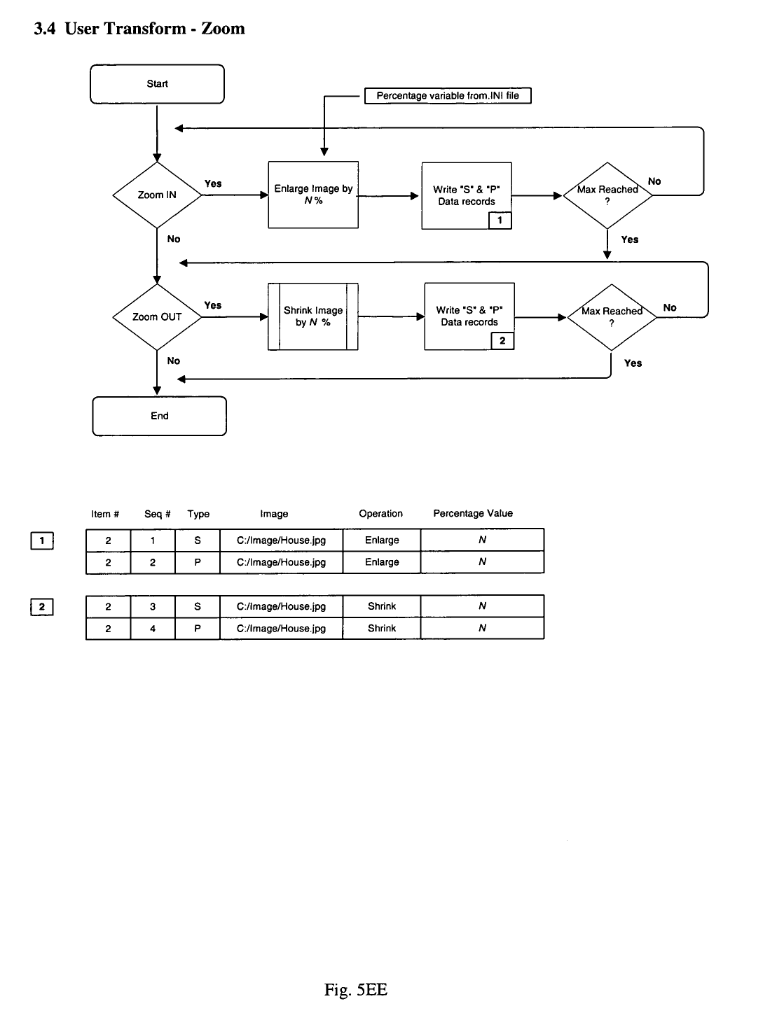

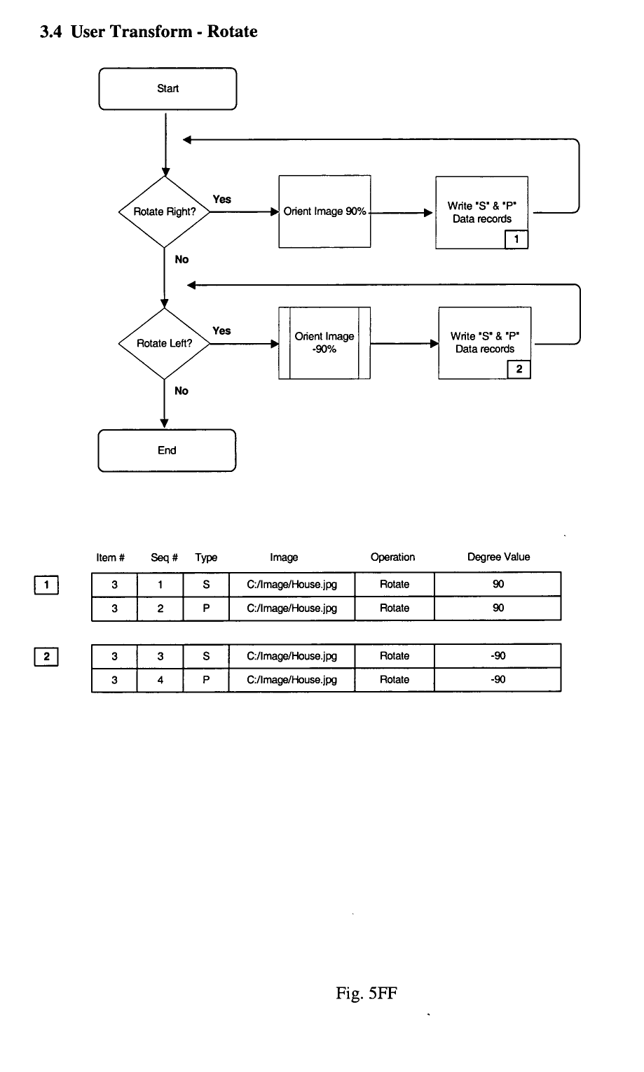

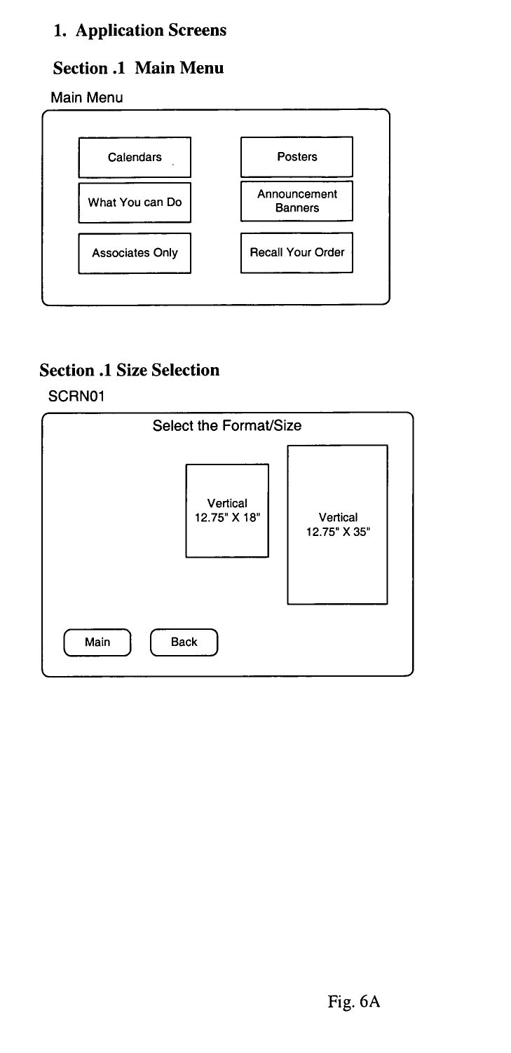

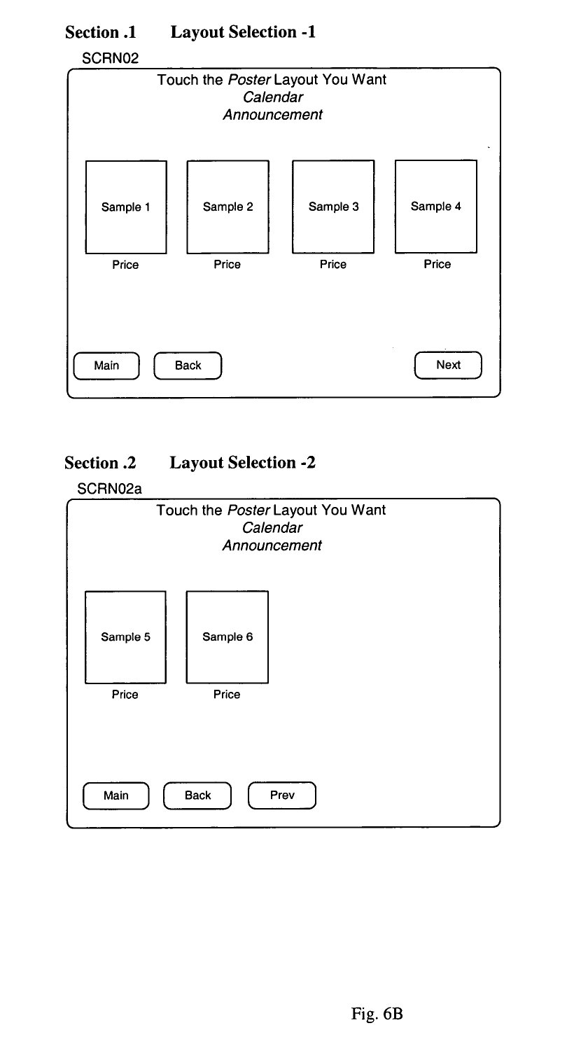

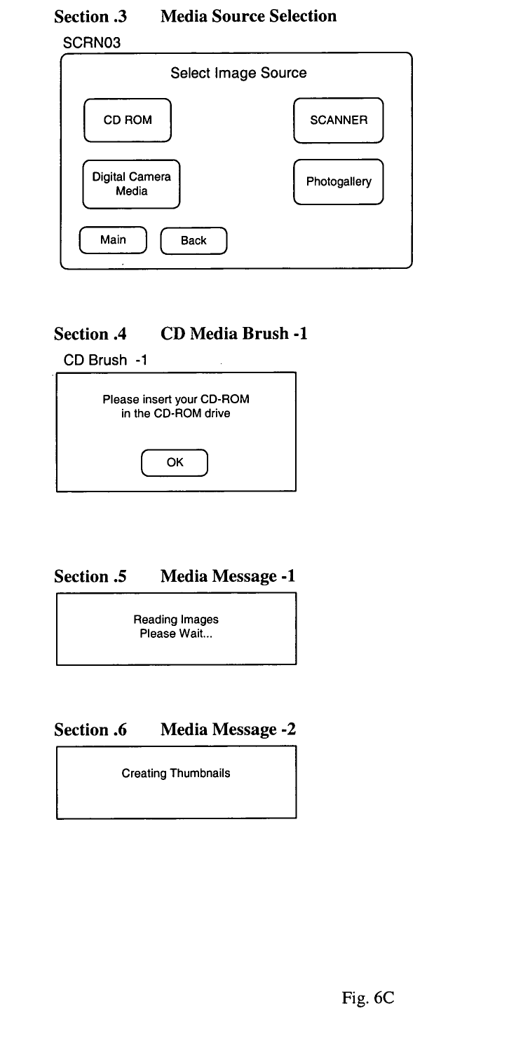

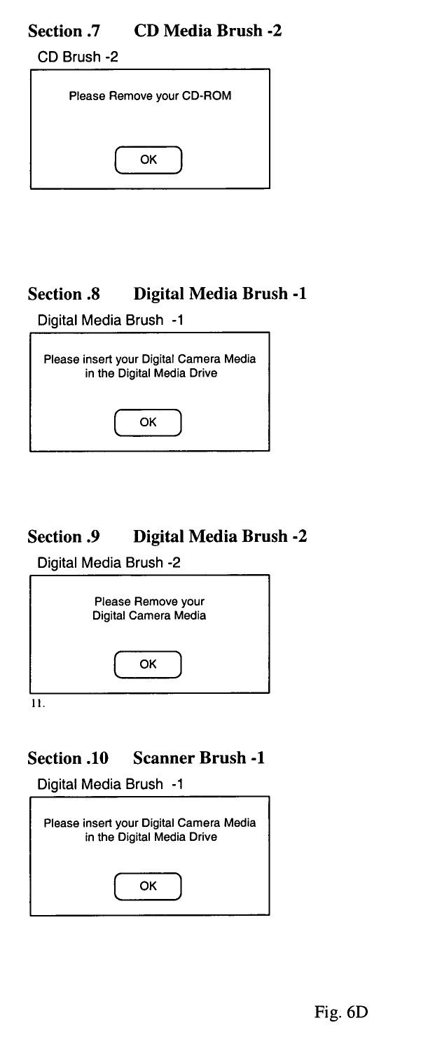

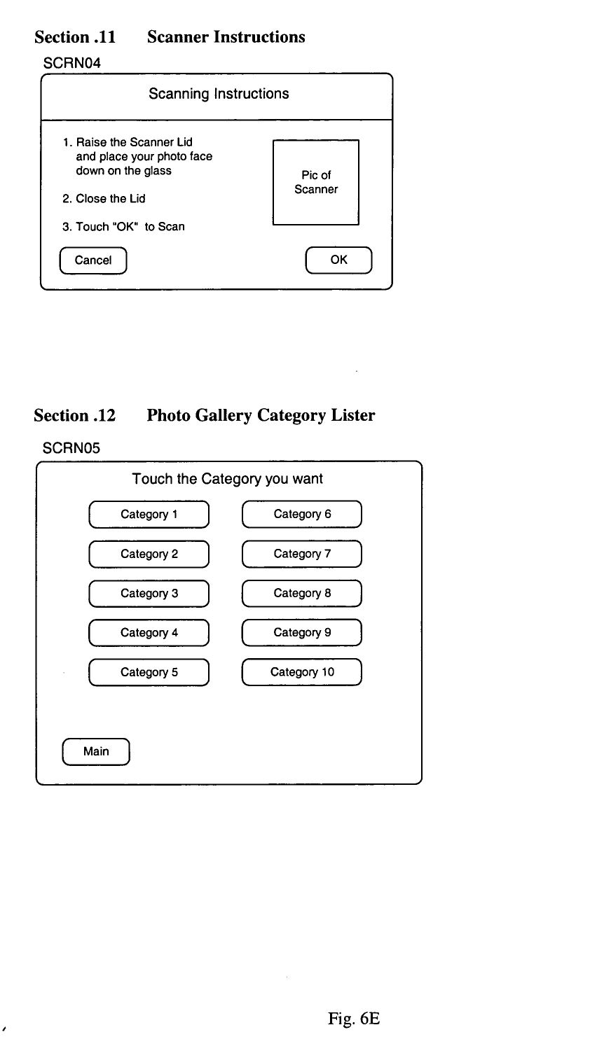

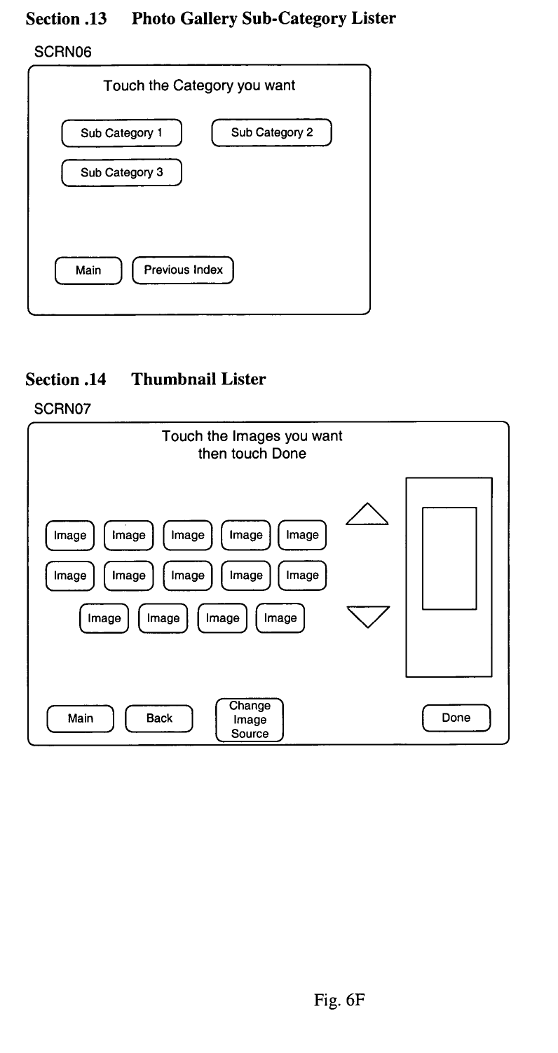

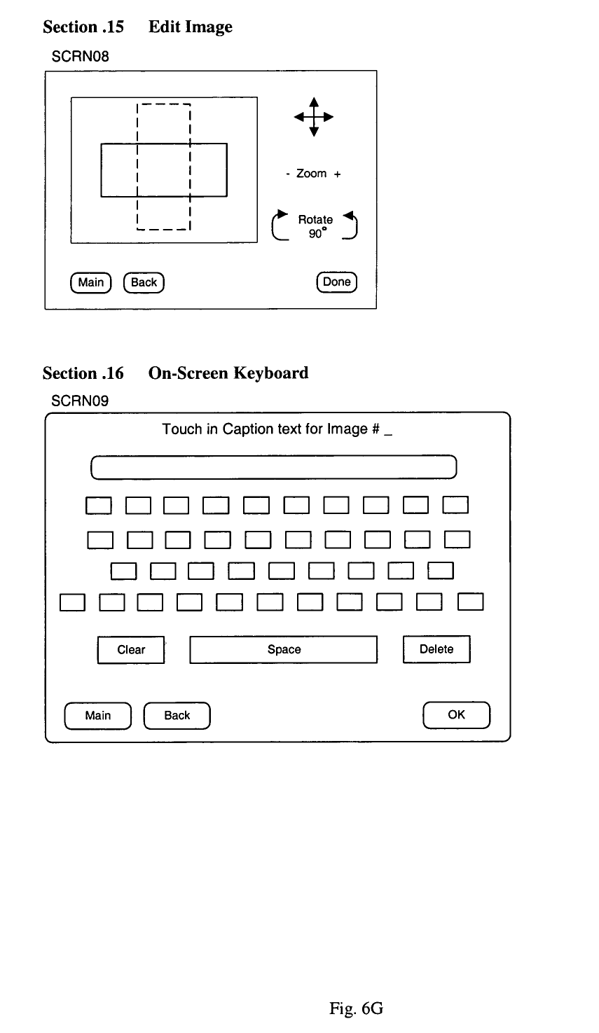

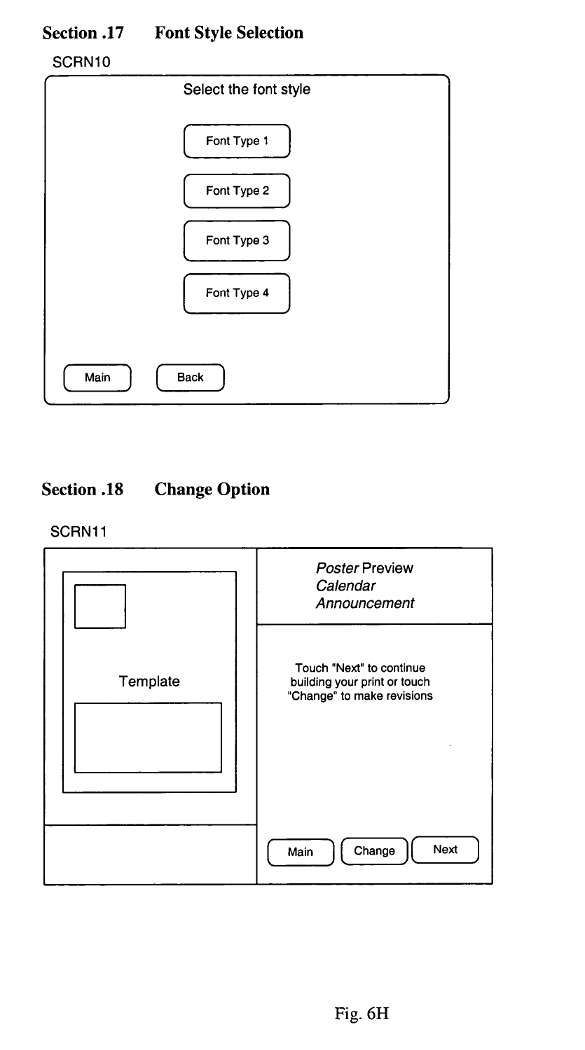

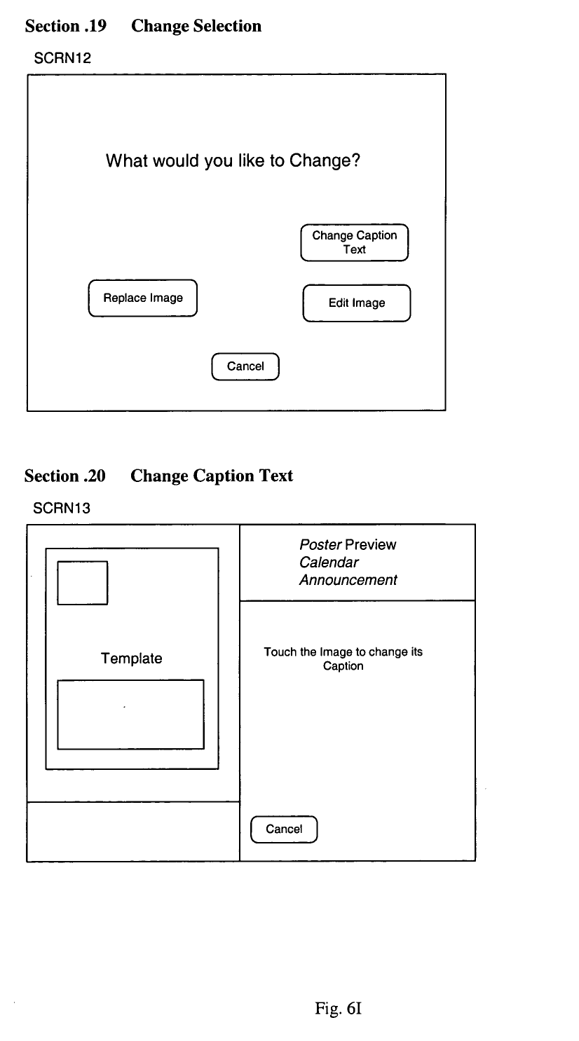

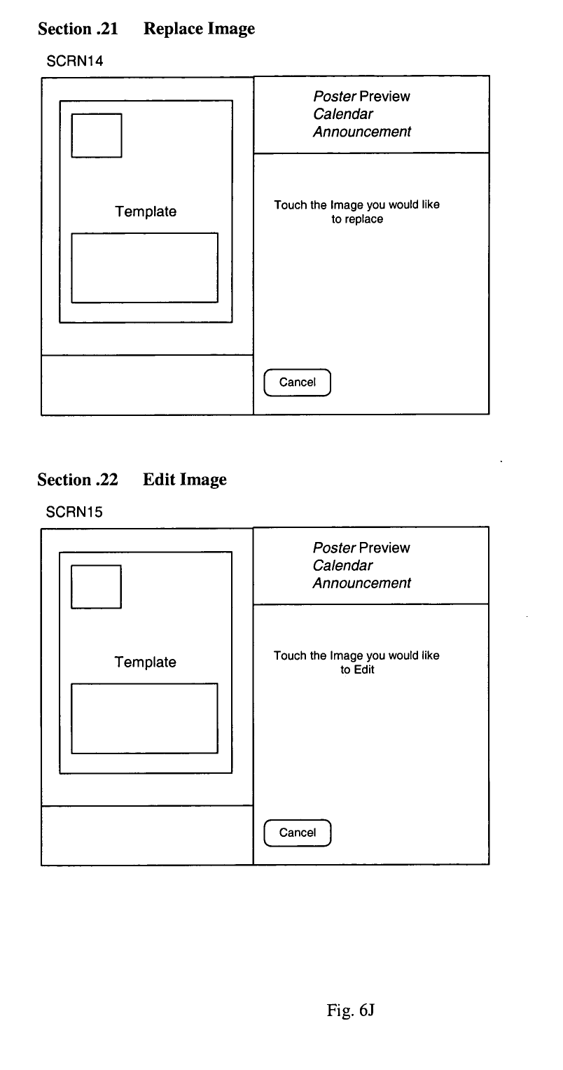

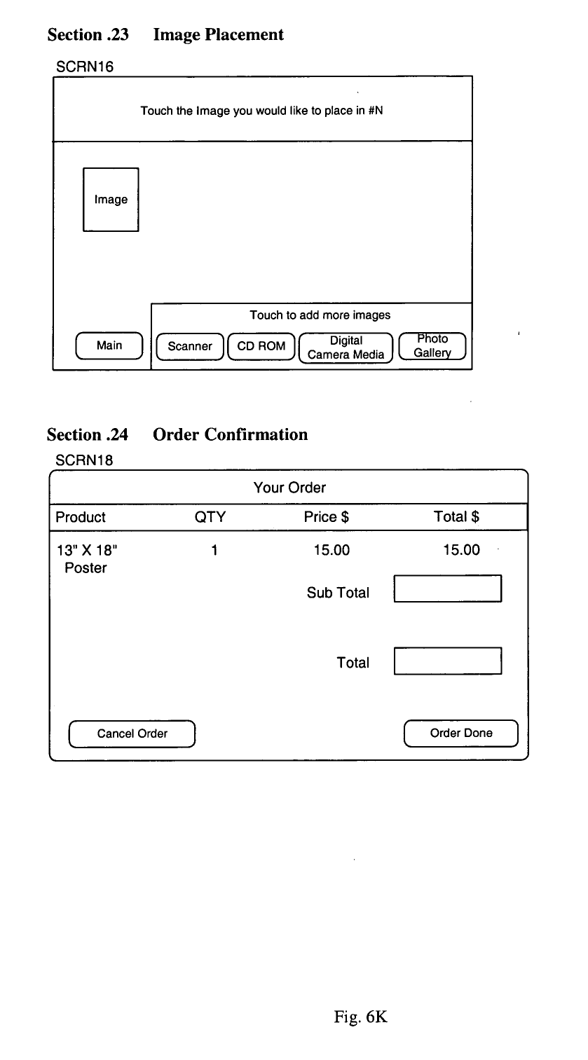

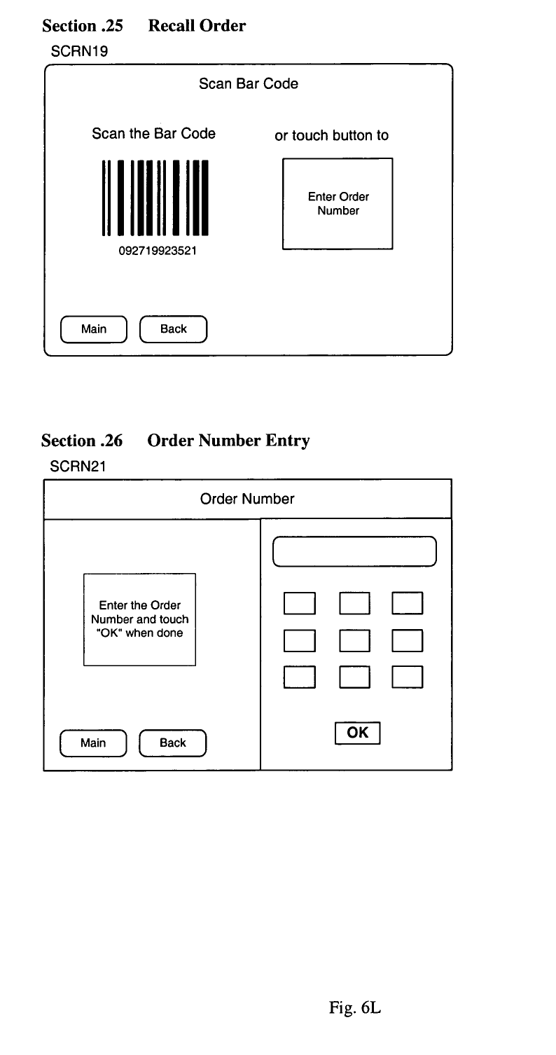

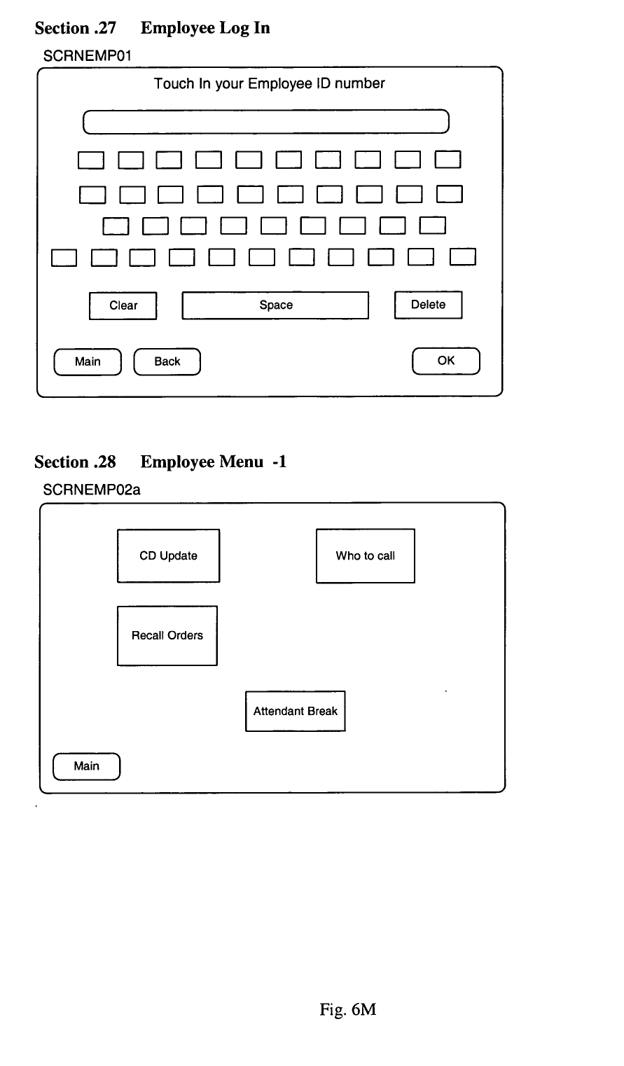

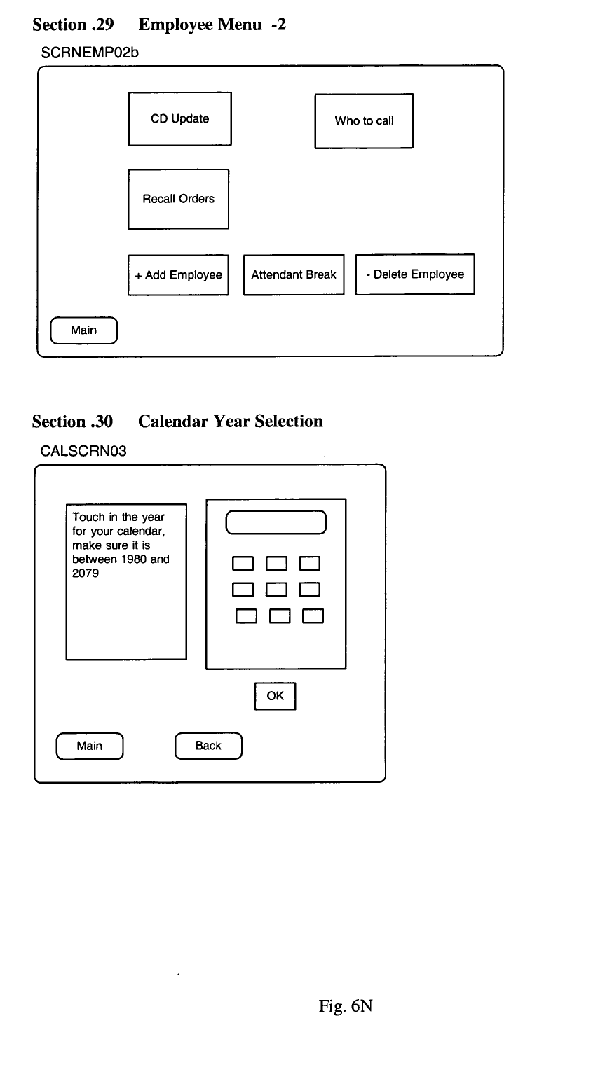

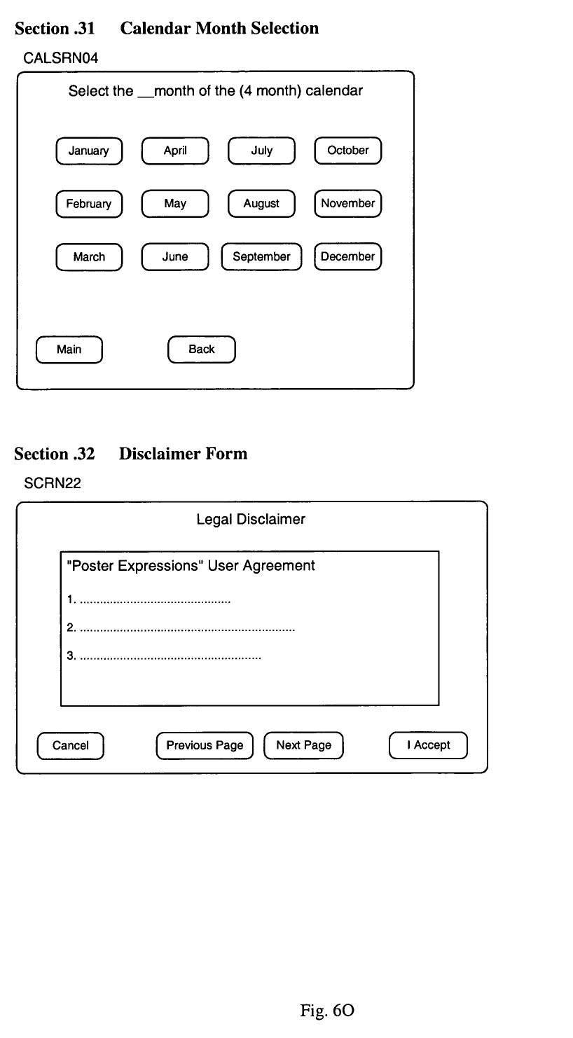

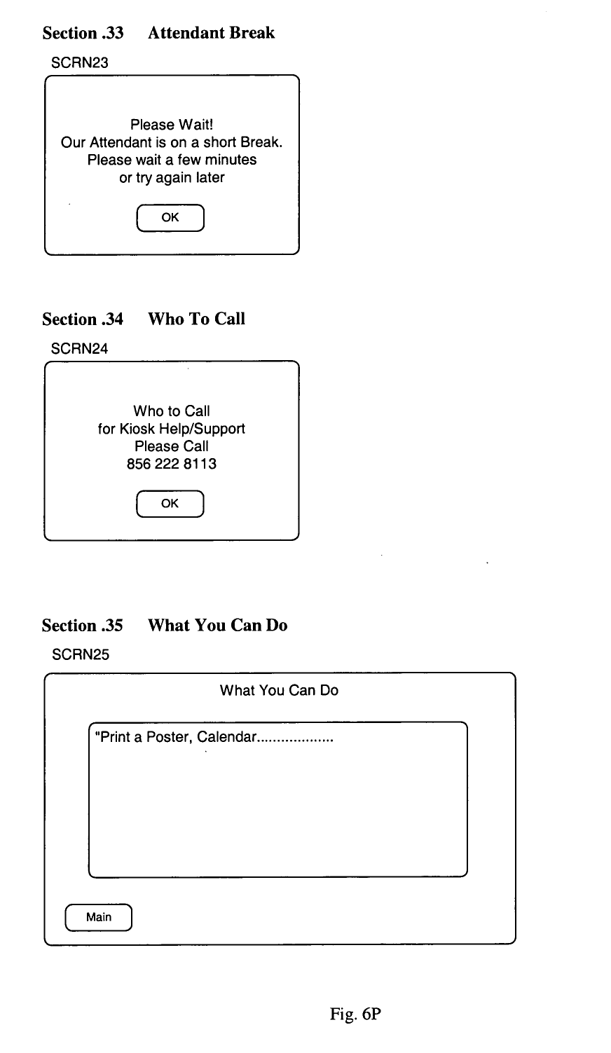

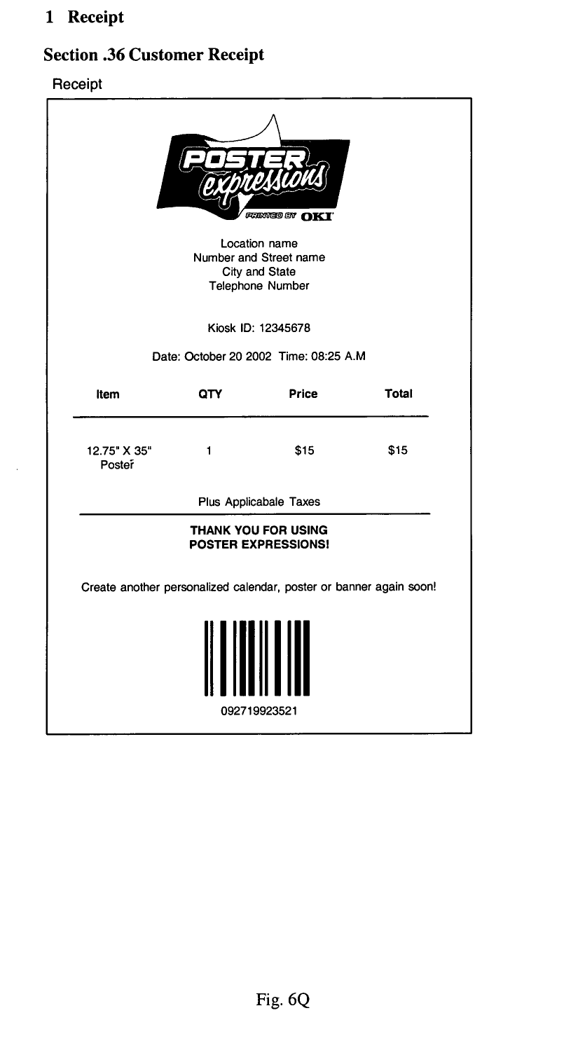

FIGS. 5A-5FF are flow diagrams illustrating, in greater detail than is shown on FIGS. 3A-3B, the functionality of the software employed for controlling the operation of the workstation kiosk 10. FIGS. 6A-6Q illustrate in greater detail the various screen layouts which may be displayed on the touch screen monitor 16 as a user creates a poster.

The present invention is a user-friendly kiosk workstation which provides a user with the ability to semi-automatically create a wide variety of poster types from both personal images and text and a library of stored images, without the need for any advanced training in the process of creating the poster. The preferred embodiment contemplates the availability of an attendant for accepting payment for the printed poster. However, one skilled in the art would appreciate that the operation of the workstation 10 does not require supervision by an attendant and therefore the attendant could be either local to the workstation or remote from the workstation. Further, while the preferred embodiment contemplates the availability of an attendant for accepting payment, it is contemplated that other embodiments of the workstation could utilize a form of charge payment such as a credit or debit card, thus obviating the need for an attendant.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

We claim:

1. A method for a user to create a poster having one or more images, said method comprising the steps of:
(a) prompting the user to select a template corresponding to a type of poster;
(b) prompting the user to select one of a plurality of image sources;
(c) receiving one or more images from the selected one of the plurality of image sources;
(d) prompting the user to select one or more of the one or more received images;
(e) repeating steps (b) through (d) until a desired number of images is selected;
(f) placing the selected images on the template; and
(g) outputting a signal representative of the poster.

2. The method of claim 1, further including the step of utilizing the output signal to print the poster.

3. The method of claim 1, further including the step of receiving an input from the user for selecting a size of the poster.

4. The method of claim 3, wherein the size of the poster may be selected to have substantially any value between approximately 5 inches and approximately 48 inches.

5. The method of claim 1, wherein the template is selected from the group consisting of a calendar, a poster and an announcement banner.

6. The method of claim 1, wherein the image sources include at least one of a CD ROM, a scanner, a digital media reader and a photo gallery of images stored within the workstation.

7. The method of claim 1, wherein the poster may be created using images received from any combination of the image sources.

8. The method of claim 1, further including the step of displaying a thumbnail representation of each image received from the selected image source.

9. The method of claim 1, further including the step of editing each selected image.

10. The method of claim 9, wherein the step of editing the selected image includes at least one of cropping, rotating, enlarging and reducing the image.

11. The method of claim 1, further including the step of adding an arbitrary selection of text to the poster.

12. The method off claim 11, wherein the text comprises a caption associated with an image.

13. The method of claim 11, wherein the text comprises a title for the poster.

14. The method of claim 11, wherein the text is selected by touching keys included in a representation of a keyboard on a touch screen monitor.

15. A workstation for printing a poster having one or more images, the components of said workstation being contained within a single housing, said components comprising:
a computer;
a memory for storing photo gallery images;
a device for inputting personal images;
a touch screen monitor for accepting information from a user; and
a printer for printing the poster, wherein the workstation combines one or more of the personal images and one or more of the photo gallery images for inclusion in the printed poster.

16. The workstation of claim 15, further including a modem.

17. The workstation of claim 15, further including a media reader for inputting personal images.

18. The workstation of claim 15, further including a CD ROM drive for inputting personal images.

19. The workstation of claim 15, further including a scanner for inputting personal images.

20. The workstation of claim 15, wherein the printer utilizes a roll feeder.

21. The workstation of claim 15, wherein the printer is capable of printing a poster of substantially any length in the range between approximately 5 inches and approximately 48 inches.

22. A workstation for creating a poster, the components of said workstation being contained within a single housing, said components comprising:
a computer;
an interface device for connecting the workstation to a remotely located server, said interface device for receiving one or more photo gallery images from the server;
a memory for storing the one or more photo gallery images, and
a touch screen monitor for simultaneously displaying the one or more photo gallery images, wherein one or more of the one or more photo gallery images stored in the memory may be selected to create the poster.

23. The workstation of claim 22, further including at least one personal input device for inputting one or more personal images to the workstation.

24. The workstation of claim 23, wherein the touch screen monitor simultaneously displays the one or more personal images, and wherein one or more of the one or more personal images may be selected to create the poster.

25. The workstation of claim 22, wherein the workstation provides diagnostics to the remote server and receives software updates from the server.

26. A method for a user to create a poster, said method comprising the steps of:
(a) prompting the user to select one of a plurality of templates, the plurality of templates being variously designed for: (1) inserting images from one or more image sources and (2) for inserting only text;
(c) Prompting the user to enter text into each of one or more predetermined portions of the selected template if the selected template is a template designed for inserting only text;
(d) outputting a signal representative of the poster.

27. The method of claim 26, further including the step of utilizing the output signal to print the poster.

28. The method of claim 26, further including the step of receiving an input from the user for selecting a size of the poster.

29. The method of claim 28, wherein the size of the poster may be selected to have substantially any value between approximately 5 inches and approximately 48 inches.

30. The method of claim 26, wherein the template is selected from the group consisting of a calendar, a poster and an announcement banner.
